(19) United States
(12) Patent Application Publication
(10) Pub. No.: US 2026/0252432 A1
(43) Pub. Date: Aug. 27, 2026

(54) LANGUAGE MODEL-BASED INCIDENT ANALYSIS AND RESOLUTION

(71) Applicant: Palantir Technologies Inc., Denver, CO (US)

(72) Inventors: Nikhil Nainani, Dubai (AE); Sebastian Münchow, Wiesendangen (CH); Mihaela-Irina Stoian, New York, NY (US)

(21) Appl. No.: 19/084,256

(22) Filed: Mar. 19, 2025

Related U.S. Application Data
(60) Provisional application No. 63/762,865, filed on Feb. 25, 2025.

(51) Int. Cl. G06F 11/07; G06Q 10/1093; H04L 41/16

(52) U.S. Cl. CPC G06F 11/079; G06Q 10/1093; H04L 41/16

(57) ABSTRACT

A system is described that utilizes one or more large language models (“LLMs”) and prior incident data to (1) summarize a potential root cause for an incident that has occurred and to propose one or more steps or operations to be executed to resolve the incident; and/or (2) identify a new incident, summarize a potential root cause for the incident, and propose one or more steps or operations to resolve the incident. By employing various implementations of the systems and methods utilizing LLMs and/or prior incident data described herein, the incident response and prevention system can quickly and accurately output steps or operations that can be executed to resolve service unavailability that has already occurred and/or can quickly and accurately identify service unavailability incidents that may occur in the future and that can clearly identify what steps or operations to execute to prevent the service unavailability incident from occurring.

### CROSS-REFERENCE TO RELATED APPLICATIONS

This application claims benefit of U.S. Provisional Patent Application No. 63/762865, filed Feb. 25, 2025, and titled “LANGUAGE MODEL-BASED INCIDENT ANALYSIS AND RESOLUTION.” The entire disclosure of each of the above items is hereby made part of this specification as if set forth fully herein and incorporated by reference for all purposes, for all that it contains.

Any and all applications for which a foreign or domestic priority claim is identified in the Application Data Sheet as filed with the present application are hereby incorporated by reference under 37 CFR 1.57 for all purposes and for all that they contain.

### TECHNICAL FIELD

The present disclosure relates to systems and techniques for utilizing computer-based models. More specifically, the present disclosure relates to computerized systems and techniques for using language models to process data.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Physical machines or computing systems may provide services to various users. In some cases, however, such physical machines or computing systems may experience downtime. As a result, the services normally provided by the physical machines or computing systems may be unavailable, negatively affecting users that rely on the services.

### SUMMARY

The systems, methods, and devices described herein each have several aspects, no single one of which is solely responsible for its desirable attributes. Without limiting the scope of this disclosure, several non-limiting features will now be described briefly.

Physical machines or computing systems can provide services to one or more users. For example, a physical machine or computing system can be a server or a group of servers that provides one or more users with access to a computing service (e.g., cloud storage, network access, data tracking, data processing, access to machine learning models, etc.), a welding machine that can be used to weld together parts, a medical device that monitors patient vital signs, a wind turbine that produces electricity for consumption, and/or the like. Such physical machines or computing systems may include hardware components and/or software that may fail, require updates, or require maintenance for various reasons, which can lead to the services offered by the physical machines or computing systems becoming unavailable until the failure, update, or maintenance issue can be resolved.

In some cases, the hardware components and/or software of the physical machines or computing systems can fail, require updates, or require maintenance without it being readily apparent what steps or operations can be executed to resolve the issue and resume services. For example, existing monitoring systems may notify a user when a service has become unavailable. However, existing monitoring systems often fail to identify the reason why the service became unavailable or what steps or operations could be executed to resolve the issue as soon as possible. As a result, users may take a trial-and-error approach in an attempt to identify the hardware components and/or software causing the service unavailability. Because users may not be able to immediately identify the cause of the service unavailability, the service may be down for an extended period of time. In fact, even if users are able to identify the cause of the service unavailability, the users may once again take a trial-and-error approach in an attempt to identify steps or operations that should be executed to resolve the service unavailability. This approach, however, can further extend the service downtime.

In some cases, service downtimes could be avoided altogether if users are provided with advance notice of impending hardware component and/or software failures, required updates, and/or required maintenance in a format that is easily understandable to a human (e.g., natural language text that accurately summarizes the issue and steps for resolving the issue). Existing monitoring systems, however, lack the technical capabilities for providing human-understandable summaries of issues and steps for resolving the issues with enough advanced notice that would allow users (or machines) to take actions to mitigate or avoid service downtimes. For example, existing monitoring systems may generate an alert or notification that notifies a user of an upcoming issue. However, the alert or notification may include specific technical details that do not clearly or accurately convey to a user how to prevent the issue from occurring. Thus, it may be desirable to implement an incident response and prevention system that can quickly and accurately output steps or operations that can be executed to resolve service unavailability that has already occurred and/or that can quickly and accurately identify service unavailability incidents that may occur in the future and that can clearly identify what steps or operations to execute to prevent the service unavailability incident from occurring.

The present disclosure describes systems and methods (generally collectively referred to herein as an “incident response and prevention system” or simply a “system”) that can advantageously overcome the technical deficiencies of existing monitoring systems described above, among other technical challenges. More specifically, various implementations of the systems and methods of the present disclosure can advantageously utilize one or more large language models (“LLMs”) and prior incident data to (1) summarize a potential root cause for an incident that has occurred and to propose one or more steps or operations to be executed to resolve the incident; and/or (2) identify a new incident that has occurred and not yet identified and/or identify a new incident that has yet to occur, summarize a potential root cause for the incident, and propose one or more steps or operations to resolve the incident or prevent the incident from occurring. By employing various implementations of the systems and methods utilizing LLMs and/or prior incident data described herein, the incident response and prevention system can quickly and accurately output steps or operations that can be executed to resolve service unavailability that has already occurred and/or can quickly and accurately identify service unavailability incidents that may occur in the future and that can clearly identify what steps or operations to execute to prevent the service unavailability incident from occurring. Advantageously, the incident response and prevention system can accomplish these operations automatically without human interaction or with reduced human interaction.

Various implementations of the present disclosure provide improvements to various technologies and technological fields. For example, as described above, the system may advantageously use an LLM to identify root causes for incidents and propose solutions for resolving the incidents in a manner that reduces service downtimes. Other technical benefits provided by various implementations of the present disclosure include, for example, predicting incidents that may occur in the future using an LLM to prevent certain services from becoming unavailable altogether.

Additionally, various implementations of the present disclosure are inextricably tied to computer technology. In particular, various implementations rely on detection of user inputs via graphical user interfaces, calculation of updates to displayed electronic data based on those user inputs, automatic processing of related electronic data, application of language models and/or other artificial intelligence, and presentation of the updates to displayed information via interactive graphical user interfaces. Such features and others (e.g., processing and analysis of large amounts of electronic data) are intimately tied to, and enabled by, computer technology, and would not exist except for computer technology. For example, the interactions with displayed data described below in reference to various implementations cannot reasonably be performed by humans alone, without the computer technology upon which they are implemented. Further, the implementation of the various implementations of the present disclosure via computer technology enables many of the advantages described herein, including more efficient interaction with, and presentation of, various types of electronic data.

According to various implementations, large amounts of data are automatically and dynamically calculated or processed interactively in response to user inputs, and the calculated data is efficiently and compactly presented to a user by the system. Thus, in some implementations, the user interfaces described herein are more efficient as compared to previous user interfaces in which data is not dynamically updated and compactly and efficiently presented to the user in response to interactive inputs.

Further, as described herein, the system may be configured and/or designed to generate user interface data useable for rendering the various interactive user interfaces described. The user interface data may be used by the system, and/or another computer system, device, and/or software program (for example, a browser program), to render the interactive user interfaces. The interactive user interfaces may be displayed on, for example, electronic displays (including, for example, touch-enabled displays).

Additionally, it has been noted that design of computer user interfaces that are useable and easily learned by humans is a non-trivial problem for software developers. The present disclosure describes various implementations of interactive and dynamic user interfaces that are the result of significant development. This non-trivial development has resulted in the user interfaces described herein which may provide significant cognitive and ergonomic efficiencies and advantages over previous systems. The interactive and dynamic user interfaces include improved human-computer interactions that may provide reduced mental workloads, improved decision-making, reduced work stress, and/or the like, for a user. For example, user interaction with the interactive user interface via the inputs described herein may provide an optimized display of, and interaction with, models and model-related data, and may enable a user to more quickly and accurately access, navigate, assess, and digest the model-related data than previous systems.

Further, the interactive and dynamic user interfaces described herein are enabled by innovations in efficient interactions between the user interfaces and underlying systems and components. For example, disclosed herein are improved methods for utilizing machine learning, natural language processing, and/or interactive visualization techniques to automatically identify root causes for incidents, propose solutions to the incidents, execute steps or operations to resolve the incidents, and/or identify potential incidents that are not yet apparent or that have not yet occurred. Advantageously, the system can perform these actions through automation to shorten the time period by which services or functionality offered by physical machines or computing systems are unavailable. Further, the system can present interactive graphical user interface(s) through visualization techniques to allow users to more easily and efficiently identify incident root causes and potential solutions.

Various combinations of the above and below recited features, embodiments, implementations, and aspects are also disclosed and contemplated by the present disclosure.

Additional implementations of the disclosure are described below in reference to the appended claims, which may serve as an additional summary of the disclosure.

In various implementations, systems and/or computer systems are disclosed that comprise one or more computer-readable storage mediums or devices comprising, configured to store, and/or storing program instructions, and one or more processors configured to execute the program instructions to cause the systems and/or computer systems to perform operations comprising one or more aspects of the above-and/or below-described implementations (including one or more aspects of the appended claims).

In various implementations, computer-implemented and/or computerized methods are disclosed in which, by one or more processors executing program instructions, one or more aspects of the above-and/or below-described implementations (including one or more aspects of the appended claims) are implemented and/or performed.

In various implementations, computer program products comprising one or more computer-readable storage mediums or devices, and/or one or more computer-readable storage mediums or devices, are disclosed, wherein the computer-readable storage mediums comprise, are configured to store, and/or store program instructions, the program instructions executable by one or more processors to cause the one or more processors to perform operations comprising one or more aspects of the above-and/or below-described implementations (including one or more aspects of the appended claims).

### BRIEF DESCRIPTION OF THE DRAWINGS

The following drawings and the associated descriptions are provided to illustrate implementations of the present disclosure and do not limit the scope of the claims. Aspects and many of the attendant advantages of this disclosure will become more readily appreciated as the same become better understood by reference to the following detailed description, when taken in conjunction with the accompanying drawings, wherein:

FIG. 1 illustrates an example computing environment including an example incident response and prevention system in communication with various devices, machines, and/or data stores to identify and resolve incidents that lead to service unavailability, according to various implementations of the present disclosure;

FIG. 2 depicts an example flow diagram of operations performed by the incident response and prevention system of FIG. 1 to generate prior embeddings;

FIG. 3A depicts an example flow diagram of operations performed by the incident response and prevention system of FIG. 1 to prioritize one or more incidents;

FIG. 3B depicts an example flow diagram of operations performed by the incident response and prevention system of FIG. 1 to identify a root cause and resolution to an incident;

FIG. 4A depicts an example flow diagram of operations performed by the incident response and prevention system of FIG. 1 to identify and summarize a potential incident in which additional information is not requested by the LLM;

FIG. 4B depicts an example flow diagram of operations performed by the incident response and prevention system of FIG. 1 to identify and summarize a potential incident in which additional information is requested by the LLM;

FIG. 5 illustrates an example routine depicting operations executed by the incident response and prevention system, the LLM, and/or the user device of FIG. 1 to identify a root cause of a current incident, identify a resolution to the current incident, and to identify a potential incident;

FIG. 6 illustrates an example routine depicting operations executed by the incident response and prevention system of FIG. 1 to identify a resolution to a current incident;

FIGS. 7A-7C and 8A-8E illustrate an example user interface for allowing a user to prioritize one or more incidents, identify a root cause of one or more incidents, and identify a proposed solution for one or more incidents; and

FIG. 9 is a block diagram of an example computer system consistent with various implementations of the present disclosure.

### DETAILED DESCRIPTION

Although certain preferred implementations, embodiments, and examples are disclosed below, the inventive subject matter extends beyond the specifically disclosed implementations to other alternative implementations and/or uses and to modifications and equivalents thereof. Thus, the scope of the claims appended hereto is not limited by any of the particular implementations described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain implementations; however, the order of description should not be construed to imply that these operations are order dependent. Additionally, the structures, systems, and/or devices described herein may be embodied as integrated components or as separate components. For purposes of comparing various implementations, certain aspects and advantages of these implementations are described. Not necessarily all such aspects or advantages are achieved by any particular implementation. Thus, for example, various implementations may be carried out in a manner that achieves or optimizes one advantage or group of advantages as taught herein without necessarily achieving other aspects or advantages as may also be taught or suggested herein.

### Overview

As mentioned above, physical machines or computing systems can provide services to one or more users. For example, a physical machine or computing system can be a server or a group of servers that provides one or more users with access to a computing service (e.g., cloud storage, network access, data tracking, data processing, access to machine learning models, etc.), a welding machine that can be used to weld together parts, a medical device that monitors patient vital signs, a wind turbine that produces electricity for consumption, and/or the like. Such physical machines or computing systems may include hardware components and/or software that may fail, require updates, or require maintenance for various reasons, which can lead to the services offered by the physical machines or computing systems becoming unavailable until the failure, update, or maintenance issue can be resolved.

In some cases, the hardware components and/or software of the physical machines or computing systems can fail, require updates, or require maintenance without it being readily apparent what steps or operations can be executed to resolve the issue and resume services. For example, existing monitoring systems may notify a user when a service has become unavailable. However, existing monitoring systems often fail to identify the reason why the service became unavailable or what steps or operations could be executed to resolve the issue as soon as possible. As a result, users may take a trial-and-error approach in an attempt to identify the hardware components and/or software causing the service unavailability. Because users may not be able to immediately identify the cause of the service unavailability, the service may be down for an extended period of time. In fact, even if users are able to identify the cause of the service unavailability, the users may once again take a trial-and-error approach in an attempt to identify steps or operations that should be executed to resolve the service unavailability. This approach, however, can further extend the service downtime.

In some cases, service downtimes could be avoided altogether if users are provided with advance notice of impending hardware component and/or software failures, required updates, and/or required maintenance in a format that is easily understandable to a human (e.g., natural language text that accurately summarizes the issue and steps for resolving the issue). Existing monitoring systems, however, lack the technical capabilities for providing human-understandable summaries of issues and steps for resolving the issues with enough advanced notice that would allow users (or machines) to take actions to mitigate or avoid service downtimes. For example, existing monitoring systems may generate an alert or notification that notifies a user of an upcoming issue. However, the alert or notification may include specific technical details that do not clearly or accurately convey to a user how to prevent the issue from occurring. Thus, it may be desirable to implement an incident response and prevention system that can quickly and accurately output steps or operations that can be executed to resolve service unavailability that has already occurred and/or that can quickly and accurately identify service unavailability incidents that may occur in the future and that can clearly identify what steps or operations to execute to prevent the service unavailability incident from occurring.

As also noted above, the present disclosure describes systems and methods (generally collectively referred to herein as an “incident response and prevention system” or simply a “system”) that can advantageously overcome the technical deficiencies of existing monitoring systems described above, among other technical challenges. More specifically, various implementations of the systems and methods of the present disclosure can advantageously utilize one or more large language models (“LLMs”) and prior incident data to (1) summarize a potential root cause for an incident that has occurred and to propose one or more steps or operations to be executed to resolve the incident; and/or (2) identify a new incident that has occurred and not yet identified and/or identify a new incident that has yet to occur, summarize a potential root cause for the incident, and propose one or more steps or operations to resolve the incident or prevent the incident from occurring. By employing various implementations of the systems and methods utilizing LLMs and/or prior incident data described herein, the incident response and prevention system can quickly and accurately output steps or operations that can be executed to resolve service unavailability that has already occurred and/or can quickly and accurately identify service unavailability incidents that may occur in the future and that can clearly identify what steps or operations to execute to prevent the service unavailability incident from occurring. Advantageously, the incident response and prevention system can accomplish these operations automatically without human interaction or with reduced human interaction.

More specifically, the incident response and prevention system can initially generate embeddings that are numerical vectors that represent learnings from incident data. For example, incident data can include information about one or more prior incidents (e.g., a type of incident that occurred, a time that the incident occurred, a consequence of the incident (e.g., a type of service that experienced downtime), how long the incident lasted until service was resolved, etc.), one or more postmortem reports previously generated in response to one or more incidents (e.g., where each postmortem report may detail why the respective incident occurred and/or one or more steps or operations executed to resolve the respective incident), user manuals that describe the functionality of hardware components and/or software that are used to implement the service experiencing downtime, one or more emails related to one or more incidents (e.g., one or more emails that were sent in response to an incident occurring), and/or any other information related to the occurrence of an incident or related to steps or operations taken to resolve an incident. The incident response and prevention system can retrieve incident data and provide the incident data with a prompt to an LLM that instructs the LLM to generate learnings based on the incident data. Learnings may include text that summarizes the context in which an incident occurred (e.g., a type of incident that occurred, a time that the incident occurred, a consequence of the incident (e.g., a type of service that experienced downtime), how long the incident lasted until service was resolved, information about hardware components and/or software that caused the incident, root cause information about the incident, etc.) and steps or operations taken to successfully resolve the incident. For ease of storage and performing future semantic searches, the incident response and prevention system can use text embeddings to then convert the learnings into embeddings (referred to herein as prior embeddings).

In response to an incident occurring, the incident response and prevention system may receive a request to prioritize one or more incidents that have occurred and identify a root cause of one of the incidents and propose a solution to the incident. In response, the incident response and prevention system can, for one or more incidents, use an LLM to score the respective incident and generate a priority score for the respective incident based on a weighted combination of the score generated by the LLM and other factors (e.g., a number of users impacted by the respective incident, a time at which the respective incident occurred, etc.). The incident response and prevention system can then use the priority scores to rank the incidents (where an incident with a higher priority score may be ranked higher than an incident with a lower priority score).

Once prioritized, the incident response and prevention system can retrieve prior embeddings, convert incident data corresponding to a prioritized incident into a current embedding, and perform a semantic search on the current embedding and the prior embeddings to identify a subset of the prior embeddings that are similar to the current embedding. The incident response and prevention system can then use an LLM to identify a resolution to the prioritized incident based on the subset of the prior embeddings. Optionally, a user may confirm (or not confirm) that the identified resolution can be executed. In response to a confirmation, the incident response and prevention system can control or send an instruction to a physical machine or computing system from which the prioritized incident originated to implement the identified resolution.

Furthermore, the incident response and prevention system can analyze logs originating from a physical machine or computing system to identify and summarize a potential incident. For example, the incident response and prevention system can perform a semantic search on current logs of a physical machine or computing system and prior logs to identify a subset of the prior logs that are similar to the current logs. The incident response and prevention system can then retrieve prior embeddings that correspond to the subset of the prior logs and use an LLM to identify and/or summarize a potential incident that is or may occur in association with the physical machine or computing system based on the prior embeddings. In some embodiments, the LLM may return an indication that more information is desired before the LLM can accurately identify and/or summarize the potential incident. In response, the incident response and prevention system can transmit an instruction to a user device to inspect the hardware components and/or software of the physical machine or computing system. Once the inspection is complete, the user device can provide to the incident response and prevention system any additional information obtained as a result of the inspection, and the incident response and prevention system can provide the additional information to the LLM to obtain an identification and/or summary of a potential incident.

Once the potential incident is identified or summarized, the incident response and prevention system can perform some or all of the operations described herein to identify a root cause of the potential incident and suggest a resolution. For example, the incident response and prevention system can retrieve prior embeddings, convert incident data corresponding to the potential incident into a current embedding, and perform a semantic search on the current embedding and the prior embeddings to identify a subset of the prior embeddings that are similar to the current embedding. The incident response and prevention system can then use an LLM to identify a resolution to the potential incident based on the subset of the prior embeddings. Optionally, a user may confirm (or not confirm) that the identified resolution can be executed. In response to a confirmation, the incident response and prevention system can control or send an instruction to a physical machine or computing system from which the potential incident originated or will originate to implement the identified resolution.

### Further Example Information Related to Various Implementations

To facilitate an understanding of the systems and methods discussed herein, several terms are described below and herein. These terms, as well as other terms used herein, should be construed to include the provided descriptions, the ordinary and customary meanings of the terms, and/or any other implied meaning for the respective terms, wherein such construction is consistent with context of the term. Thus, the descriptions below and herein do not limit the meaning of these terms, but only provide example descriptions.

The term “model,” as used in the present disclosure, can include any computer-based models of any type and of any level of complexity, such as any type of sequential, functional, or concurrent model. Models can further include various types of computational models, such as, for example, artificial neural networks (“NN”), language models (e.g., large language models (“LLMs”)), artificial intelligence (“AI”) models, machine learning (“ML”) models, multimodal models (e.g., models or combinations of models that can accept inputs of multiple modalities, such as images and text), and/or the like. A “nondeterministic model” as used in the present disclosure, is any model in which the output of the model is not determined solely based on an input to the model. Examples of nondeterministic models include language models such as LLMs, ML models, and the like.

A Language Model is any algorithm, rule, model, and/or other programmatic instructions that can predict the probability of a sequence of words. A language model may, given a starting text string (e.g., one or more words), predict the next word in the sequence. A language model may calculate the probability of different word combinations based on the patterns learned during training (based on a set of text data from books, articles, websites, audio files, etc.). A language model may generate many combinations of one or more next words (and/or sentences) that are coherent and contextually relevant. Thus, a language model can be an advanced artificial intelligence algorithm that has been trained to understand, generate, and manipulate language. A language model can be useful for natural language processing, including receiving natural language prompts and providing natural language responses based on the text on which the model is trained. A language model may include an n-gram, exponential, positional, neural network, and/or other type of model.

A Large Language Model (“LLM”) is any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. An LLM may comprise a NN trained using self-supervised learning. An LLM may be of any type, including a Question Answer (“QA”) LLM that may be optimized for generating answers from a context, a multimodal LLM/model, and/or the like. An LLM (and/or other models of the present disclosure), may include, for example, attention-based and/or transformer architecture or functionality. LLMs can be useful for natural language processing, including receiving natural language prompts and providing natural language responses based on the text on which the model is trained. LLMs may not be data security-or data permissions-aware, however, because they generally do not retain permissions information associated with the text upon which they are trained. Thus, responses provided by LLMs are typically not limited to any particular permissions-based portion of the model.

While certain aspects and implementations are discussed herein with reference to use of a language model, LLM, and/or AI, those aspects and implementations may be performed by any other language model, LLM, AI model, generative AI model, generative model, ML model, NN, multimodal model, and/or other algorithmic processes. Similarly, while certain aspects and implementations are discussed herein with reference to use of a ML model, language model, or LLM, those aspects and implementations may be performed by any other AI model, generative AI model, generative model, NN, multimodal model, and/or other algorithmic processes.

In various implementations, the LLMs and/or other models (including ML models) of the present disclosure may be locally hosted, cloud managed, accessed via one or more Application Programming Interfaces (“APIs”), and/or any combination of the foregoing and/or the like. Additionally, in various implementations, the LLMs and/or other models (including ML models) of the present disclosure may be implemented in or by electronic hardware such application-specific processors (e.g., application-specific integrated circuits (“ASICs”)), programmable processors (e.g., field programmable gate arrays (“FPGAs”)), application-specific circuitry, and/or the like. Data that may be queried using the systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data, and/or the like.

Examples of models, language models, and/or LLMs that may be used in various implementations of the present disclosure include, for example, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), Generative Pre-trained Transformer 3 (GPT-3), Generative Pre-trained Transformer 4 (GPT-4), LLaMA (Large Language Model Meta AI), and BigScience Large Open-science Open-access Multilingual Language Model (BLOOM).

A Prompt (or “Natural Language Prompt” or “Model Input”) can be, for example, a term, phrase, question, and/or statement written in a human language (e.g., English, Chinese, Spanish, and/or the like), and/or other text string, that may serve as a starting point for a language model and/or other language processing. A prompt may include only a user input or may be generated based on a user input, such as by a prompt generation module (e.g., of a document search system) that supplements a user input with instructions, examples, and/or information that may improve the effectiveness (e.g., accuracy and/or relevance) of an output from the language model. A prompt may be provided to an LLM which the LLM can use to generate a response (or “model output”).

A User Operation (or “User Input”) can be any operations performed by one or more users to user interface(s) and/or other user input devices associated with a system (e.g., the data extraction system). User operation can include a request for task(s) to be performed, such as by using a machine learning model and/or an LLM, in whole or in part. User operation can include a request for data, such as data accessed and/or processed by one or more services. User operation can include one or more queries, one or more questions, one or more requests, or the like. User operation may include one or more natural language instructions for some data analysis (e.g., prediction, estimation, classification, or the like) to be performed. User operations can include, for example, select, drag, move, group, or the like, one or more interactive graphical representations for updating an ontology.

An Incident can be any event, occurrence, situation, and/or the like in which a hardware component and/or software of a physical machine or computing system fails, malfunctions, requires an update, requires maintenance, or is otherwise unable to perform an intended action or operation, thereby leading to the unavailability of one or more services or functionality offered by the physical machine or computing system. An incident can occur at a particular time, can impact a set number of users in a particular region who rely on the service or functionality offered by the physical machine or computing system, can be indicated by the occurrence of a log, an alert, a notification, etc., and/or the like.

A Data Store is any computer-readable storage medium and/or device (or collection of data storage mediums and/or devices). Examples of data stores include, but are not limited to, optical disks (e.g., CD-ROM, DVD-ROM, and the like), magnetic disks (e.g., hard disks, floppy disks, and the like), memory circuits (e.g., solid state drives, random-access memory (RAM), and the like), and/or the like. Another example of a data store is a hosted storage environment that includes a collection of physical data storage devices that may be remotely accessible and may be rapidly provisioned as needed (commonly referred to as “cloud” storage). According to various implementations, any data storage, data stores, databases, and/or the like described in the present disclosure may, in various implementations, be replaced by appropriate alternative data storage, data stores, databases, and/or the like.

A Database is any data structure (and/or combinations of multiple data structures) for storing and/or organizing data, including, but not limited to, relational databases (e.g., Oracle databases, PostgreSQL databases, MySQL databases, and the like), non-relational databases (e.g., NoSQL databases, and the like), in-memory databases, spreadsheets, comma separated values (CSV) files, eXtensible markup language (XML) files, TeXT (TXT) files, flat files, spreadsheet files, and/or any other widely used or proprietary format for data storage. Databases are typically stored in one or more data stores. Accordingly, each database referred to herein (e.g., in the description herein and/or the figures of the present application) can be understood as being stored in one or more data stores. Additionally, although the present disclosure may show or describe data as being stored in combined or separate databases, in various implementations such data may be combined and/or separated in any appropriate way into one or more databases, one or more tables of one or more databases, and/or the like. According to various implementations, any database(s) described in the present disclosure may be replaced by appropriate data store(s). Further, data source(s) of the present disclosure may include one or more databases, one or more tables, one or more data sources, and/or the like, for example.

### Example System and Related Computing Environment

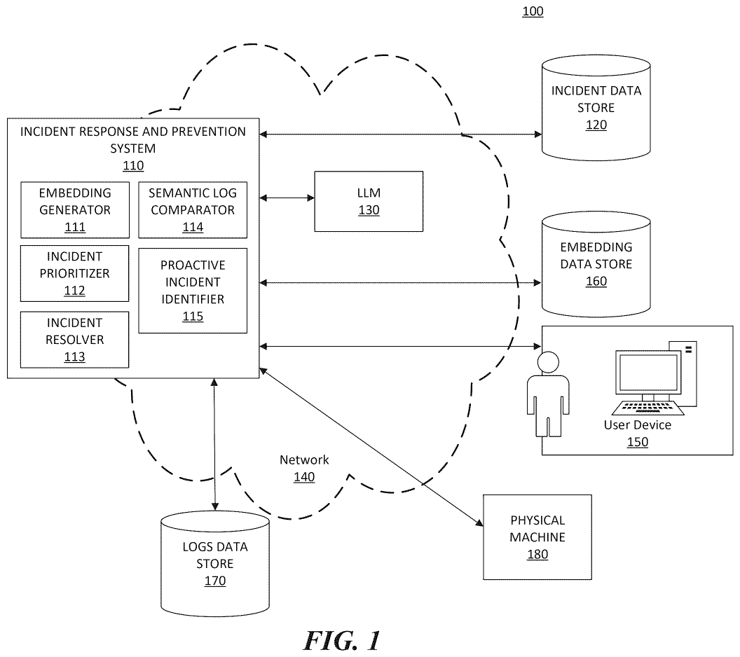

FIG. 1 illustrates an example computing environment 100 including an example incident response and prevention system 110 in communication with various devices, machines, and/or data stores to identify and resolve incidents that lead to service unavailability, according to various implementations of the present disclosure. The example computing environment 100 includes the incident response and prevention system 110, one or more LLMs 130, a network 140, an incident data store 120, a user device 150 (and/or user computing device), an embedding data store 160, a logs data store 170, and one or more physical machines 180. In the example of FIG. 1, the incident response and prevention system 110 comprises various modules or components, including an embedding generator 111, an incident prioritizer 112, an incident resolver 113, a semantic log comparator 114, and a proactive incident identifier 115. In other implementations, the incident response and prevention system 110 may include fewer or additional components.

In the example of FIG. 1, the various devices are in communication via a network 140, which may include any combination of networks, such as one or more local area network (LAN), personal area network (PAN), wide area network (WAN), Global System for Mobile Communications (GSM) network, a Code Division Multiple Access (CDMA) network, a Long Term Evolution (LTE) network, the Internet, and/or any other communication network. The network 140 can use protocols and components for communicating via the Internet or any of the other aforementioned types of networks. For example, the protocols used by the network 140 may include Hypertext Transfer Protocol (HTTP), HTTP Secure (HTTPS), Message Queue Telemetry Transport (MQTT), Constrained Application Protocol (CoAP), and the like. In various implementations, modules or components of the illustrated components, such as the embedding generator 111, the incident prioritizer 112, the incident resolver 113, the semantic log comparator 114, and the proactive incident identifier 115 of the incident response and prevention system 110, may communicate via an internal bus and/or via the network 140.

The embedding generator 111 can be configured to use text embeddings to convert learnings into embeddings. For example, the embeddings can be numerical vectors that represent learnings from incident data. Incident data can include information about one or more prior incidents (e.g., a type of incident that occurred, a time that the incident occurred, a consequence of the incident (e.g., a type of service that experienced downtime), how long the incident lasted until service was resolved, etc.), one or more postmortem reports previously generated in response to one or more incidents (e.g., where each postmortem report may detail why the respective incident occurred and/or one or more steps or operations executed to resolve the respective incident), user manuals that describe the functionality of hardware components and/or software that are used to implement the service experiencing downtime, one or more emails related to one or more incidents (e.g., one or more emails that were sent in response to an incident occurring), and/or any other information related to the occurrence of an incident or related to steps or operations taken to resolve an incident. The embedding generator 111 can retrieve incident data from the incident data store 120 and provide the incident data with a prompt to the LLM 130 that instructs the LLM 130 to generate learnings based on the incident data. Learnings may include text that summarizes the context in which an incident occurred (e.g., a type of incident that occurred, a time that the incident occurred, a consequence of the incident (e.g., a type of service that experienced downtime), how long the incident lasted until service was resolved, information about hardware components and/or software that caused the incident, root cause information about the incident, etc.) and steps or operations taken to successfully resolve the incident. For ease of storage and performing future semantic searches, the embedding generator 111 can use text embeddings to convert the learnings into embeddings (referred to herein as prior embeddings). The embedding generator 111 can then store the prior embeddings in the embedding data store 160.

The incident prioritizer 112 may be configured to prioritize one or more incidents that have occurred. The incident prioritizer 112 may prioritize the incident(s) for a user to inform the user about which incident(s) should be resolved first to reduce overall service downtimes. The incident prioritizer 112 may begin prioritizing one or more incidents in response to a request from a user device 150, where the request may identify a single incident to prioritize or multiple incidents to prioritize. The request may further include information about each incident, such as a user-generated report describing the respective incident. The incident prioritizer 112 can determine a priority ranking for one or more incidents based on priority scores determined for each incident. Each priority score may be determined based on a weighted combination of unstructured data (e.g., a user-generated report of an incident) and/or structured data (e.g., a number of users in a region impacted by the incident, an amount of time that has passed since the incident occurred, etc.). Specifically, the incident prioritizer 112 can transmit a report of an incident to the LLM 130 with a prompt that instructs the LLM 130 to generate a score for the report based on a sentiment analysis of content of the report (where the score may represent a severity of the incident based on a sentiment of the text of the report, and where a higher (or lower) score may represent a higher severity). As an illustrative example, the score generated by the LLM 130 may range between 1 to 10, where 10 may represent the highest severity. For each incident, the incident prioritizer 112 can determine a weighted combination of the score for the report associated with the respective incident produced by the LLM 130, a number of users impacted by the respective incident, a time at which the respective incident occurred (or an amount of time that has passed since the incident occurred), and/or other factors, thereby forming a priority score for the respective incident. The incident prioritizer 112 can then use the priority scores to rank the incidents (where an incident with a higher priority score may be ranked higher than an incident with a lower priority score).

In further embodiments, the incident prioritizer 112 or a separate system or component of the incident response and prevention system 110 (not shown) can train an ML model to determine the prioritization of one or more incidents. For example, the incident prioritizer 112 or separate system or component can train the ML model using training data that includes one or more training data items that each correspond to a prior incident, where each training data item may include a score produced by the LLM 130 based on a report of the respective prior incident, a number of users impacted by the respective prior incident, a region that was impacted by the respective prior incident, an amount of time that had passed since the respective prior incident occurred, and/or the like and be labeled with an indication of a priority rank (or priority score) assigned to the respective prior incident. Once trained, the incident prioritizer 112 could provide the score generated by the LLM 130 based on a report of a current incident, an indication of the number of users impacted by the current incident, an indication of a region impacted by the current incident, an amount of time has passed since the current incident occurred, and/or the like as an input to the trained ML model, which may cause the trained ML model to output a priority rank (or priority score) to assign to the current incident. The incident prioritizer 112 could perform these operations in place of determining the weighted combination.

Optionally, the incident prioritizer 112 can use feedback from users obtained via one or more user devices 150 to re-train or update the trained ML model. For example, the incident prioritizer 112 can use the output of the trained ML model to cause a user interface displayed on a user device 150 to display the incidents in the prioritized order indicated by the output of the trained ML model. The user interface may allow a user to either indicate that the prioritized ranking is inaccurate and how the incidents should be ranked or to re-rank the incidents according to the user's preferences. The incident prioritizer 112 can receive, from the user device 150, information about how the incidents should have been ranked, generate training data based on this information that includes training data elements similar to those described above, and re-train or update the trained ML model using the generated training data.

The incident resolver 113 can be configured to identify a root cause of an incident, propose a solution for resolving the incident, and/or implement the solution. For example, in response to a request from a user device 150 to identify the root cause of a current incident that led to physical machine 180 service unavailability and propose a solution, the incident resolver 113 can retrieve prior embeddings from the embedding data store 160, convert incident data corresponding to the current incident into a current embedding, and perform a semantic search on the current embedding and the prior embeddings to identify a subset of the prior embeddings that are similar to the current embedding. As used herein, a semantic search can include identifying the cosine similarity or cosine distance between a first input and a second set of inputs to identify which of the second set of inputs are similar to the first input. The incident resolver 113 can then transmit the subset of the prior embeddings to the LLM 130 with a prompt that instructs the LLM 130 to generate a resolution to the current incident based on the subset of the prior embeddings. The LLM 130 can generate the resolution and provide the generated resolution to the incident resolver 113. The generated resolution may include an identification of one or more steps or operations that can be executed by and/or with respect to the physical machine 180 to resolve the current incident. As an illustrative example, a step or operation can include shutting down a computing device of the physical machine 180, restarting a server of the physical machine 180, disabling an operating system service of the physical machine 180, removing a hardware component from the physical machine 180, ceasing data transmissions to the physical machine 180, changing a communication protocol used to communicate with the physical machine 180 or used by the physical machine 180 to communicate with a separate system, and/or any other action that can be performed with respect to the hardware components and/or software of the physical machine 180 or a separate system that interacts with the physical machine 180. The incident resolver 113 can then generate user interface data that, when processed by a user device 150, causes the user device 150 to render and display a user interface that identifies one or more steps or operations to execute to resolve the incident.

Optionally, a user via the user device 150 may confirm (or not confirm) that the identified resolution can be executed. In response to a confirmation, the incident resolver 113 implement the resolution. For example, the incident resolver 113 can transmit an instruction to the physical machine 180 to instruct the physical machine 180 to execute one or more steps or operations of the generated resolution or can transmit a command to the physical machine 180 that causes the physical machine 180 to execute one or more steps or operations of the generated resolution. As another example, the incident resolver 113 can transmit an instruction to a separate system (not shown) that interacts with the physical machine 180 to execute one or more steps or operations of the generated resolution or can transmit a command to the separate system that causes the separate system to execute one or more steps or operations of the generated resolution. As an illustrative example, the incident resolver 113 can transmit a command to the physical machine 180 to restart a computing device of the physical machine 180. Thus, the incident resolver 113 may not only identify a resolution to a current incident, but also may execute operations to implement the resolution and resolve the current incident.

The semantic log comparator 114 can be configured to perform a semantic search of one or more logs and identify similar logs. As described herein, logs can be generated by the physical machine 180 and can include alphanumeric text that describes the status of operations of part of or all of the physical machine 180. As an illustrative example, the physical machine 180 can be a wind turbine, and logs generated by the physical machine 180 can include sensor measurements captured by one or more sensors of the wind turbine, timestamps of the sensor measurements, and/or the like. Alternatively or in addition, logs can include images (e.g., drone captured images of the physical machine 180, screenshots of user interfaces produced by the physical machine 180, etc.), audio (e.g., sound produced by the physical machine 180), and/or any other type of media related to the physical machine 180.

The proactive incident identifier 115 can be configured to identify potential incidents that have occurred and have not yet been identified or that are about to occur based on logs data (e.g., data that includes one or more logs) associated with a physical machine 180. For example, a user device 150 can identify to the semantic log comparator 114 one or more current logs to analyze to identify potential incident(s). The current logs may be selected by a user based on the logs identifying errors or warnings, could be selected automatically by a user device 150 based on a threshold being satisfied (e.g., the number of logs with an error or warning originating from a single pod (e.g., an independent computer in a server) or multiple pods exceeded a threshold number of error or warning logs within a threshold time period), could be selected automatically by a user device 150 based on a pattern being identified (e.g., logs typically included data with a certain mean and standard deviation and now some or all of the logs include data that fall outside the standard deviation), and/or the like. In response, the semantic log comparator 114 can retrieve prior logs data (e.g., data that includes one or more prior logs previously generated by the physical machine 180 associated with the current logs, by another physical machine 180, or by multiple physical machines 180) stored in the logs data store 170. The semantic log comparator 114 can perform a semantic search on the current logs and the prior logs to identify a subset of the prior logs that are similar to the current logs. The semantic log comparator 114 can then query the embedding data store 160 for prior embeddings that correspond to the subset of prior logs. For example, some or all of the prior logs may correspond to prior incidents that occurred (e.g., a prior log or a set of prior logs may identify a prior incident or provide data related to a prior incident). If a prior log corresponds to a prior incident that occurred, a prior embedding corresponding to the prior incident may be stored in the embedding data store 160.

The proactive incident identifier 115 may receive an indication of the prior embeddings that correspond to the subset of prior logs. The proactive incident identifier 115 can then transmit to the LLM 130 the prior embeddings with a prompt that instructs the LLM 130 to identify and summarize a potential incident (or multiple potential incidents) based on the prior embeddings and/or to request additional information if no potential incident can be identified. In some embodiments, the LLM 130 identifies one or more potential incidents based on the prior embeddings and outputs an identification and summary of the potential incident(s). The proactive incident identifier 115 can then generate user interface data that, when processed by a user device 150, causes the user device 150 to render and display a user interface that identifies and summarizes the potential incident(s).

In other embodiments, the LLM 130 is unable to identify one or more potential incidents based on the prior embeddings and outputs such an indication to the proactive incident identifier 115. In response, the proactive incident identifier 115 may transmit a message to the user device 150 instructing the user to perform a manual (or machine-enabled) inspection of the hardware components and/or software of the physical machine 180. Alternatively or in addition, the proactive incident identifier 115 can add a meeting to a calendar of the user of the user device 150 to remind the user to perform or initiate the inspection at a certain time and day. The inspection may lead to additional information being gathered by the user, such as the physical appearance of hardware components, the presence or lack of presence of certain hardware components, the functionality of a hardware component or software, and/or the like. The user device 150 can transmit this additional information to the proactive incident identifier 115, and the proactive incident identifier 115 can relay the additional information to the LLM 130 as an additional input (optionally with the original inputs and prompt). In this embodiment, the LLM 130 may now output to the proactive incident identifier 115 an identification and summary of one or more potential incidents, which the proactive incident identifier 115 can then relay to the user device 150 via the user interface and generated user interface data.

Once the potential incident(s) are identified or summarized, the incident resolver 113 can perform some or all of the operations described herein to identify a root cause of the potential incident and suggest a resolution. For example, the incident resolver 113 can retrieve prior embeddings, convert incident data corresponding to the potential incident into a current embedding, and perform a semantic search on the current embedding and the prior embeddings to identify a subset of the prior embeddings that are similar to the current embedding. The incident resolver 113 can then transmit to the LLM 130 the subset of the prior embeddings with a prompt that instructs the LLM 130 to generate a resolution of the potential incident based on the subset of the prior embeddings. The incident resolver 113 can then relay the output of the LLM 130 to the user device 150 via the user interface and generated user interface data. Optionally, a user via the user device 150 may confirm (or not confirm) that the identified resolution can be executed. In response to a confirmation, the incident resolver can cause the physical machine 180 or a separate system (not shown) that interacts with the physical machine 180 to perform some or all of the steps or operations of the generated resolution.

As described herein, the LLM 130 may be instructed to generate summaries of current incidents, root causes of current incidents, resolutions to current incidents, potential incidents, root causes of potential incidents, and/or resolutions to potential incidents. Any component of the incident response and prevention system 110 can instruct the LLM 130 to generate a single summary for an incident, root cause, or resolution, or to generate multiple summaries for an incident, root cause, or resolution. For example, in an embodiment in which multiple summaries are generated, one summary may be a high-level summary that is useful for long-term planning (e.g., patterns identified across multiple incidents, such as all servers acquired from entity A experience issue B, whereas all servers acquired from entity C do not experience issue B) and that does not include low-level details (e.g., the name of a kernel experiencing a fault, lines of code that are causing an issue, a subcomponent of a hardware component experiencing a failure, etc.), and another summary may be a detailed summary useful for an engineer tasked with resolving a specific incident (e.g., a summary that includes low-level details, but not necessarily high-level details that describe patterns across multiple incidents).

The incident data store 120 can be configured to store incident data for one or more prior and/or current incidents. While the incident data store 120 is depicted as being external to the incident response and prevention system 110, this is not meant to be limiting. For example, the incident data store 120 can be located internal to the incident response and prevention system 110.

The embedding data store 160 can be configured to store prior embeddings. While the embedding data store 160 is depicted as being external to the incident response and prevention system 110, this is not meant to be limiting. For example, the embedding data store 160 can be located internal to the incident response and prevention system 110.

The logs data store 170 can be configured to store logs (e.g., logs data) generated by or in association with one or more physical machines 180. While the logs data store 170 is depicted as being external to the incident response and prevention system 110, this is not meant to be limiting. For example, the logs data store 170 can be located internal to the incident response and prevention system 110.

The user device 150 can be any computing system with one or more hardware processors capable of executing computer-executable instructions to perform one or more operations and/or with a display for displaying various user interfaces. For example, the user device 150 can be a mobile phone, a laptop, a desktop, a tablet, a wearable device, a television, a watch, a virtual reality or augmented reality headset, an appliance, and/or the like.

The physical machine 180 can be any machine or computing system that includes hardware components and/or software and that provides a service to a user or that performs one or more actions to produce an output. For example, the physical machine 180 can be a server or a group of servers that provides one or more users with access to a computing service (e.g., cloud storage, network access, data tracking, data processing, access to machine learning models, etc.), a welding machine that can be used to weld together parts, a medical device that monitors patient vital signs, a wind turbine that produces electricity for consumption, and/or the like. Such physical machines or computing systems may include hardware components and/or software that may fail, require updates, or require maintenance for various reasons, which can lead to the services or functionality offered by the physical machines or computing systems becoming unavailable until the failure, update, or maintenance issue can be resolved.

### Example Flow Diagrams

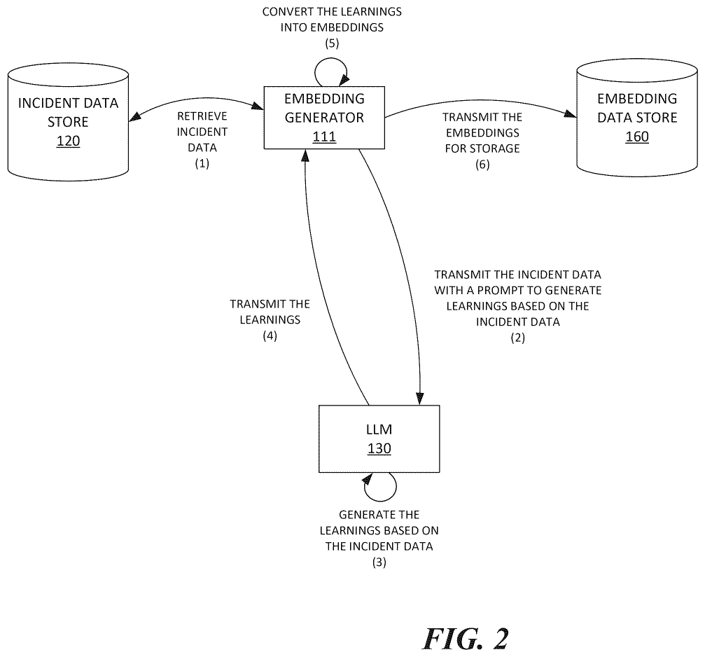

FIG. 2 depicts an example flow diagram of operations performed by the incident response and prevention system 110 of FIG. 1 to generate prior embeddings. As illustrated in FIG. 2, the embedding generator 111 can retrieve incident data from the incident data store 120 at (1). The embedding generator 111 can retrieve the incident data asynchronously of a user requesting information regarding an incident or a potential incident.

The embedding generator 111 can transmit the incident data to the LLM 130 with a prompt that instructs the LLM 130 to generate learnings based on the incident data at (2). In response, the LLM 130 can generate the learnings based on the incident data at (3), and transmit the learnings to the embedding generator 111 at (4).

The embedding generator 111 can convert the learnings into embeddings at (5). For example, the embedding generator 111 can use text embeddings (e.g., an embedding model that converts text into vectors) to convert the learnings into embeddings. The embedding generator 111 can then transmit the embeddings to the embedding data store 160 at (6) for storage as prior embeddings.

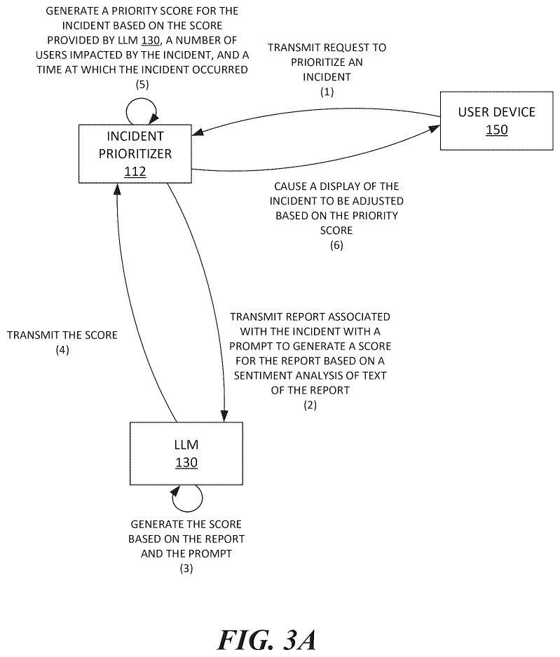

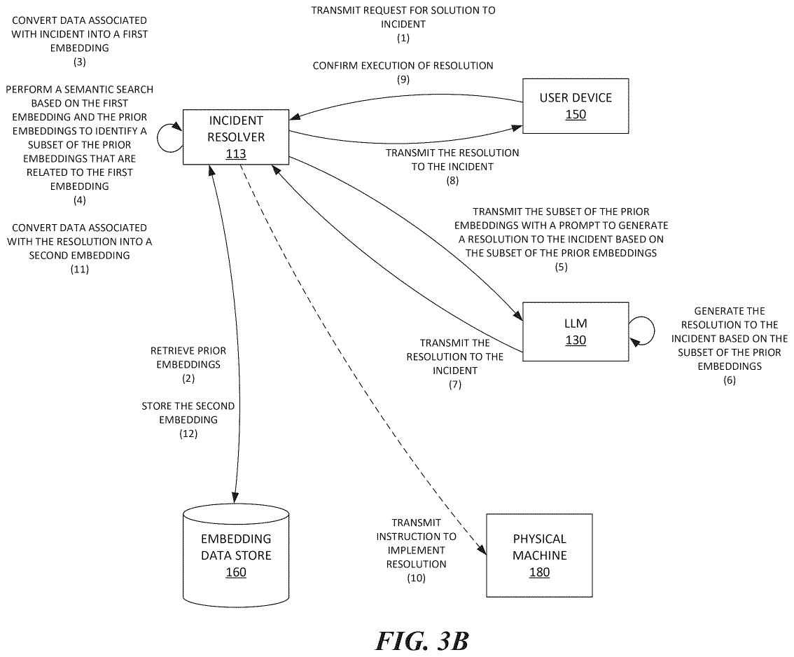

FIG. 3A depicts an example flow diagram of operations performed by the incident response and prevention system 110 of FIG. 1 to prioritize one or more incidents. As illustrated in FIG. 3A, a user device 150 transmits to the incident prioritizer 112 a request to prioritize an incident at (1). The user device 150 may transmit the request in response to user input received via a user interface displayed by the user device 150. The request may include information about the incident, such as a user-generated report describing the incident.

The incident prioritizer 112 can transmit the report associated with the incident to the LLM 130 at (2) with a prompt that instructs the LLM 130 to generate a score for the report based on a sentiment analysis of content (e.g., text) of the report. In response, the LLM 130 can generate the score based on the report and the prompt at (3), and can transmit the score to the incident prioritizer 112 at (4).

The incident prioritizer 112 can generate a priority score for the incident based on the score provided by the LLM 130, a number of users impacted by the incident, and a time at which the incident occurred (or a time that has passed since the incident occurred) at (5). For example, the incident prioritizer 112 can determine a weighted combination or sum of these factors. The incident prioritizer 112 can then cause the user device 150 to adjust a display of the incident based on the priority score at (6). For example, the incident prioritizer 112 can generate user interface data that, when processed by the user device 150, causes the user device 150 to render and display a user interface that depicts the incident and/or other incidents in accordance with the priority score of the incident (e.g., the incident may be displayed in the user interface above other incidents with lower priority scores), and transmit the user interface data to the user device 150.

FIG. 3B depicts an example flow diagram of operations performed by the incident response and prevention system 110 of FIG. 1 to identify a root cause and resolution to an incident. As illustrated in FIG. 3B, a user device 150 transmits to the incident resolver 113 a request for a solution to an incident at (1). The user device 150 may transmit this request subsequent to requesting a prioritization of one or more incidents. In some embodiments, the incident identified in this request may be the incident with the highest priority.

The incident resolver 113 can retrieve prior embeddings from the embedding data store 160 at (2). The incident resolver 113 can then convert data associated with the incident into a first embedding at (3). For example, the incident resolver 113 can use text embeddings to convert the incident data of the incident into the first embedding. The incident resolver 113 can then perform a semantic search based on the first embedding and the prior embeddings at (4) to identify a subset of the prior embeddings that are related or similar to the first embedding. For example, the incident resolver 113 can perform a cosine similarity or cosine distance operation to identify those prior embeddings that are within a threshold distance of the first embedding (which are referred to herein as the subset of prior embeddings).

The incident resolver 113 can transmit the subset of the prior embeddings to the LLM 130 at (5) with a prompt that instructs the LLM 130 to generate a resolution to the incident based on the subset of the prior embeddings. In response, the LLM 130 can generate the resolution to the incident based on the subset of the prior embeddings at (6), and can transmit to the incident resolver 113 the resolution to the incident at (7). Optionally, the resolution to the incident can include an indication of a root cause of the incident and any other information related to the occurrence of the incident or to resolving the incident.

The incident resolver 113 can transmit the resolution to the incident to the user device 150 at (8). For example, the incident resolver 113 can generate user interface data that, when processed by the user device 150, causes the user device 150 to render and display a user interface that identifies the root cause of the incident and/or one or more steps or operations to execute to resolve the incident. The incident resolver 113 can then transmit the user interface data to the user device 150.

In some embodiments, the user via the user device 150 can confirm to the incident resolver 113 execution of the resolution to the incident at (9). For example, the user may confirm that the steps or operations identified as being a possible solution to the incident will resolve the incident or may generally approve of the steps or operations being executed in an attempt to resolve the incident. Optionally, in response to receiving such a confirmation, the incident resolver 113 can transmit at (10) an instruction to the physical machine 180 associated with the incident that instructs the physical machine 180 to implement one or more steps or operations of the resolution to the incident.

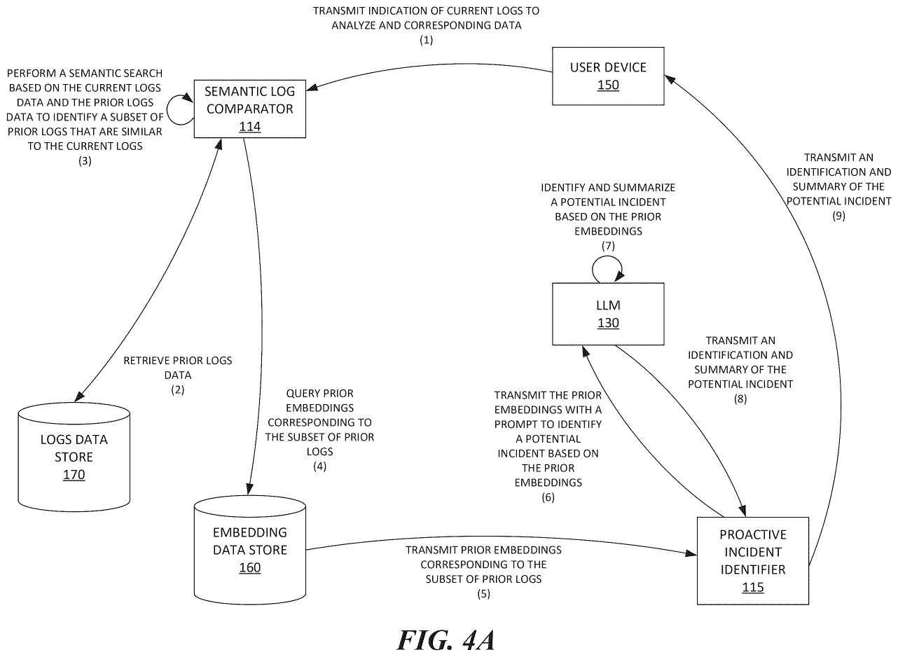

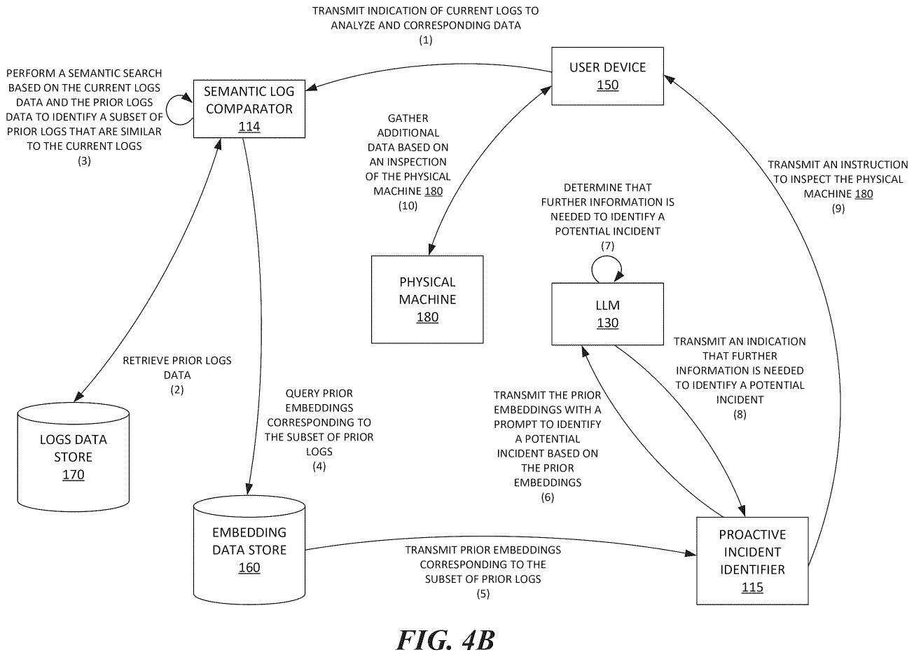

FIG. 4A depicts an example flow diagram of operations performed by the incident response and prevention system 110 of FIG. 1 to identify and summarize a potential incident in which additional information is not requested by the LLM 130. As illustrated in FIG. 4A, a user device 150 transmits to the semantic log comparator 114 an indication of current logs to analyze and corresponding data at (1). For example, the user device 150 may select the current logs based on the logs identifying errors or warnings, based on a threshold being satisfied (e.g., the number of logs with an error or warning originating from a single pod (e.g., an independent computer in a server) or multiple pods exceeded a threshold number of error or warning logs within a threshold time period), based on a pattern being identified (e.g., logs typically included data with a certain mean and standard deviation and now some or all of the logs include data that fall outside the standard deviation), and/or the like. The corresponding data can include the current logs themselves and/or any metadata associated with the current logs.

The semantic log comparator 114 can retrieve prior logs data from the logs data store 170 at (2). The semantic log comparator 114 can then perform a semantic search based on the current logs data and the prior logs data to identify a subset of the prior logs that are similar to the current logs at (3). For example, the semantic log comparator 114 can perform a cosine similarity or cosine distance operation to identify those prior logs that are within a threshold distance of the current logs (which are referred to herein as the subset of prior logs). The semantic log comparator 114 can then query the embedding data store 160 for prior embeddings that correspond to the subset of prior logs at (4).

The proactive incident identifier 115 may receive from the embedding data store 160 the prior embeddings that correspond to the subset of prior logs at (5). The proactive incident identifier 115 can then transmit the prior embeddings to the LLM 130 at (6) with a prompt that instructs the LLM 130 to identify a potential incident based on the prior embeddings. In response, the LLM 130 identifies and summarizes a potential incident based on the prior embeddings at (7), and transmits to the proactive incident identifier 115 an identification and summary of the potential incident at (8).

The proactive incident identifier 115 can then transmit an identification and summary of the potential incident to the user device 150 at (9). For example, the proactive incident identifier 115 can generate user interface data that, when processed by the user device 150, causes the user device 150 to render and display a user interface that depicts the identification of the potential incident and a summary of the potential incident. The proactive incident identifier 115 can then transmit the user interface data to the user device 150.

FIG. 4B depicts an example flow diagram of operations performed by the incident response and prevention system 110 of FIG. 1 to identify and summarize a potential incident in which additional information is requested by the LLM 130. As illustrated in FIG. 4B, a user device 150 transmits to the semantic log comparator 114 an indication of current logs to analyze and corresponding data at (1). For example, the user device 150 may select the current logs based on the logs identifying errors or warnings, based on a threshold being satisfied (e.g., the number of logs with an error or warning originating from a single pod (e.g., an independent computer in a server) or multiple pods exceeded a threshold number of error or warning logs within a threshold time period), based on a pattern being identified (e.g., logs typically included data with a certain mean and standard deviation and now some or all of the logs include data that fall outside the standard deviation), and/or the like. The corresponding data can include the current logs themselves and/or any metadata associated with the current logs.

The semantic log comparator 114 can retrieve prior logs data from the logs data store 170 at (2). The semantic log comparator 114 can then perform a semantic search based on the current logs data and the prior logs data to identify a subset of the prior logs that are similar to the current logs at (3). For example, the semantic log comparator 114 can perform a cosine similarity or cosine distance operation to identify those prior logs that are within a threshold distance of the current logs (which are referred to herein as the subset of prior logs). The semantic log comparator 114 can then query the embedding data store 160 for prior embeddings that correspond to the subset of prior logs at (4).

The proactive incident identifier 115 may receive from the embedding data store 160 the prior embeddings that correspond to the subset of prior logs at (5). The proactive incident identifier 115 can then transmit the prior embeddings to the LLM 130 at (6) with a prompt that instructs the LLM 130 to identify a potential incident based on the prior embeddings. In response, the LLM 130 determines that further information is needed to identify a potential incident at (7), and transmits to the proactive incident identifier 115 an indication that further information is needed to identify a potential incident at (8).

The proactive incident identifier 115 can then transmit to the user device 150 an instruction to inspect the physical machine 180 from which the current logs originate at (9). In response, the user device 150 may gather additional data from the physical machine 180 based on an inspection of the physical machine 180 at (10). The user device 150 can then relay this additional data to the proactive incident identifier 115, and the proactive incident identifier 115 can provide the additional data (and/or the original input and prompt) as an input to the LLM 130, which causes the LLM 130 to then identify and summarize a potential incident. The proactive incident identifier 115 can receive the information about the potential incident from the LLM 130 and cause the user device 150 to display this information.

### Example Flowcharts

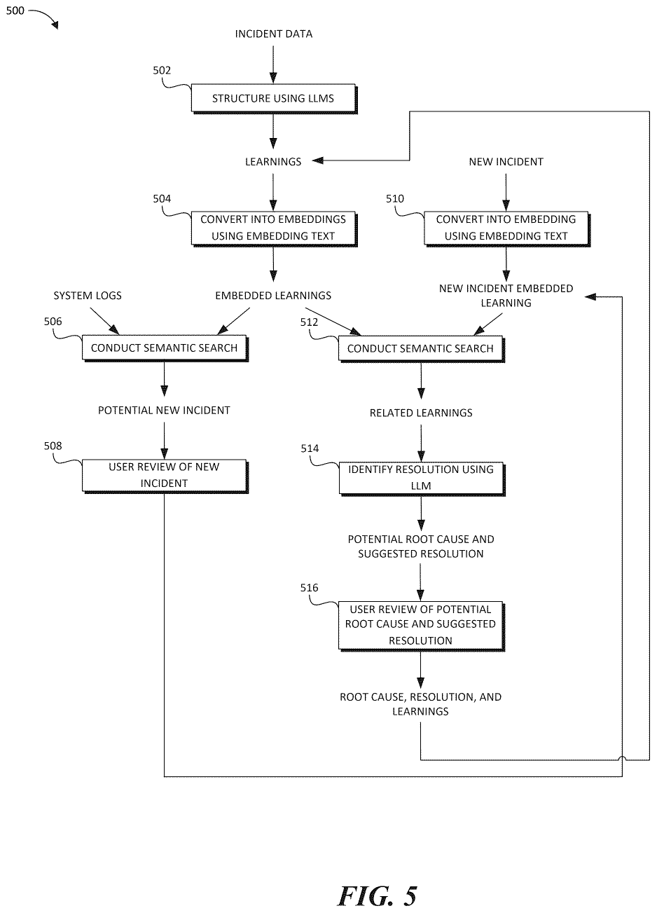

FIG. 5 illustrates an example routine 500 depicting operations executed by the incident response and prevention system 110, the LLM 130, and/or the user device 150 of FIG. 1 to identify a root cause of a current incident, identify a resolution to the current incident, and to identify a potential incident. As illustrated in FIG. 5, the routine 500 begins at block 502 if embeddings are to be generated, at block 506 if a potential new incident is to be identified, or at block 510 if a root cause and suggested resolution to a new incident is requested.

At block 502, incident data is received and structured using one or more LLMs. For example, the LLM(s) can structure the incident data into learnings. The routine 500 then proceeds to block 504.

At block 504, the learnings are converted into embedded learnings (also referred to herein as embeddings or prior embeddings) using embedding text (also referred to herein as text embeddings or an embedding model). The routine 500 then proceeds to block 506 if a user device 150 has requested information on a potential incident or to block 512 if a user device 150 has requested information on an existing and known incident.

At block 506, a semantic search is conducted on the embedded learnings to identify which embedded learnings are similar to system logs of a physical machine 180. Conducting the semantic search may lead to the identification of a potential new incident. The routine 500 then proceeds to block 508.

At block 508, a user reviews the potential new incident. For example, the user can review a summary of the potential new incident. If the user seeks further information, such as a root cause of and/or resolution to the potential new incident, then the routine 500 proceeds to block 512 and the routine 500 attempts to identify the root cause of and/or resolution to the potential new incident.

At block 510, data associated with a new incident is converted into an embedding using embedding text. The embedding is referred to as a new incident embedded learning. The routine 500 then proceeds to block 512.

At block 512, a semantic search is conducted on the embedded learnings to identify which embedded learnings are similar to the new incident embedded learning. The embedded learnings thar are similar to the new incident embedded learning may be referred to as related learnings. The routine 500 then proceeds to block 514.

At block 514, a suggested resolution to the new incident is identified using an LLM. The LLM may generate a suggested resolution and identify a root cause of the new incident. The routine 500 then proceeds to block 516.

At block 516, a user reviews the potential root cause and suggested resolution. If the user implements the suggested resolution or instructs the incident response and prevention system 110 to implement the suggested resolution, the routine 500 may revert back to block 504 and learnings derived from the potential root cause and suggested resolution may be converted into a prior embedding for storage and later use when analyzing a future incident.

The blocks of the routine 500 illustrate example implementations, and in various other implementations various blocks may be rearranged, optional, and/or omitted, and/or additional block may be added.

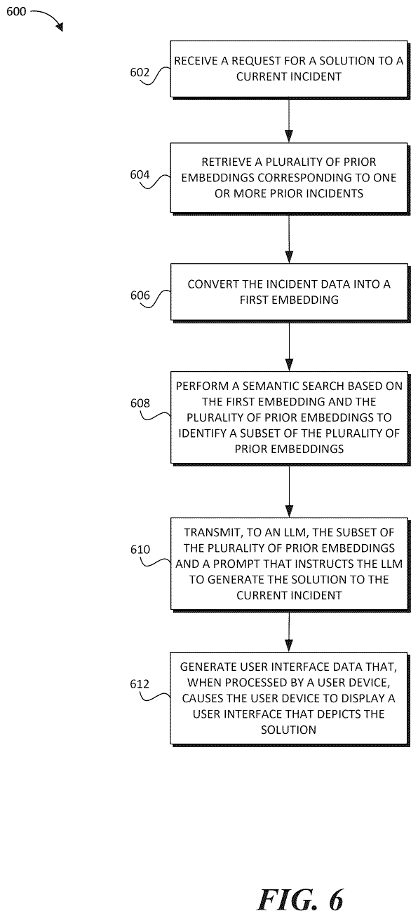

FIG. 6 illustrates an example routine 600 depicting operations executed by the incident response and prevention system 110 of FIG. 1 to identify a resolution to a current incident. As illustrated in FIG. 6, the routine 600 begins at block 602.

At block 602, a request for a solution to a current incident is received. The request may include incident data corresponding to the current incident. The current incident may have occurred with respect to a service or functionality provided by a physical machine 180, where the current incident results in the service or functionality becoming unavailable.

At block 604, a plurality of prior embeddings corresponding to one or more prior incidents is retrieved. The plurality of prior embeddings may have been derived from incident data of the one or more prior incidents.

At block 606, the incident data is converted into a first embedding. For example, the incident data can be converted into the first embedding using an embedding model.

At block 608, a semantic search is performed based on the first embedding and the plurality of prior embeddings to identify a subset of the plurality of prior embeddings. The subset of the plurality of prior embeddings may be those prior embeddings that are similar to the first embedding. For example, each of the subset of the plurality of prior embeddings and the first embedding may have a cosine distance less than a threshold cosine distance.

At block 610, the subset of the plurality of prior embeddings are transmitted to the LLM with a prompt that instructs the LLM to generate a solution to the current incident. In response, the LLM can identify a root cause of the current incident and a solution to the current incident based on the subset of the plurality of prior embeddings.

At block 612, user interface data is generated that, when processed by a user device, causes the user device to display a user interface that depicts the solution. The user interface may further identify the root case of the current incident. Optionally, the user can approve the solution via the user interface, which may cause the incident response and prevention system 110 to implement the solution automatically. After the user interface data is generated, the routine 600 ends.

The blocks of the routine 600 illustrate example implementations, and in various other implementations various blocks may be rearranged, optional, and/or omitted, and/or additional block may be added.

### Example User Interfaces

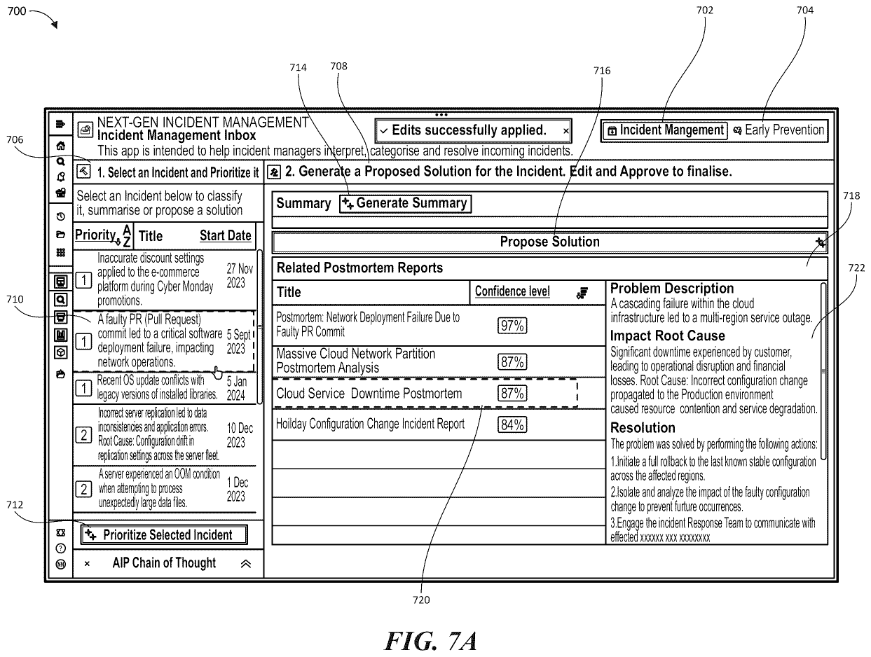

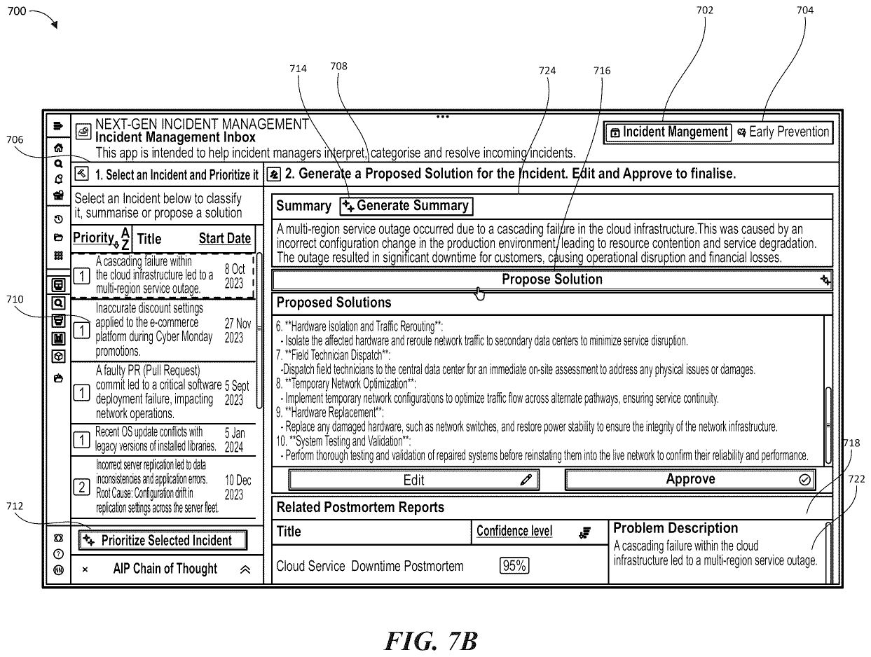

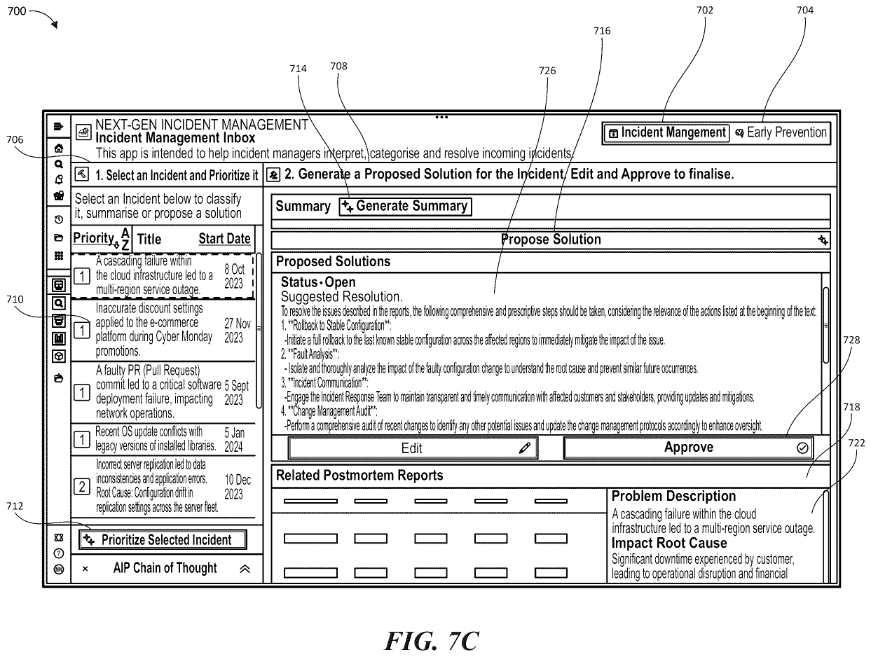

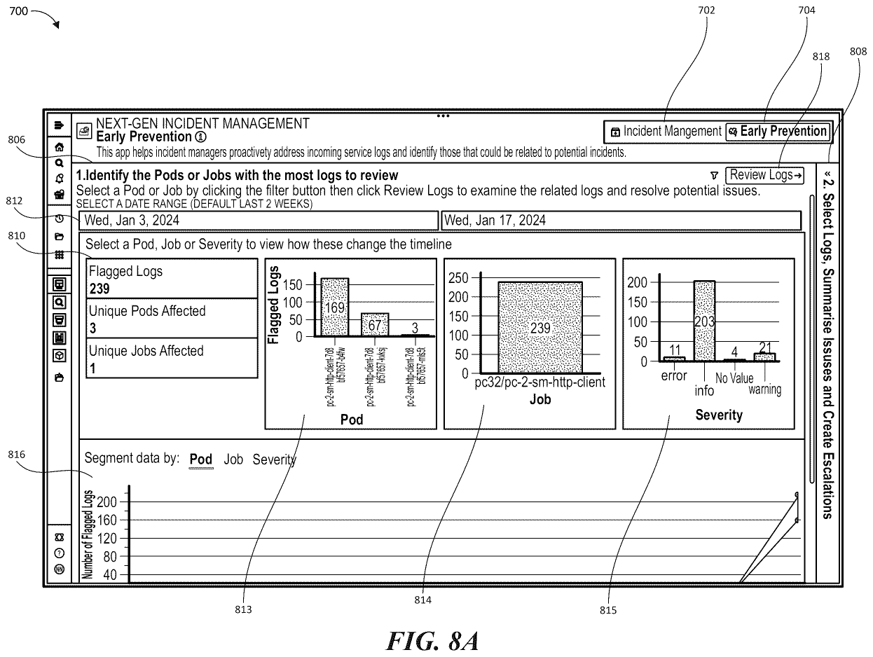

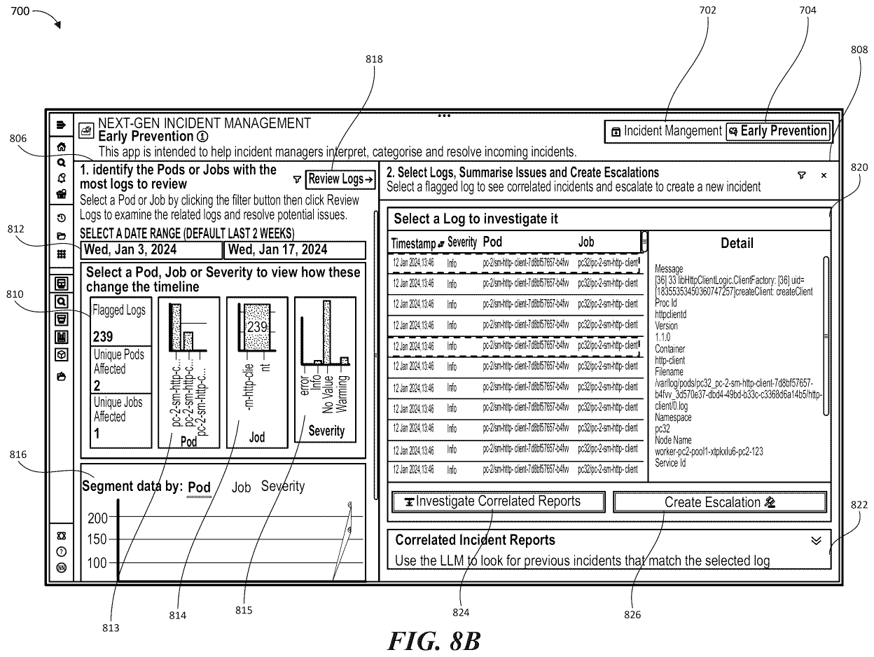

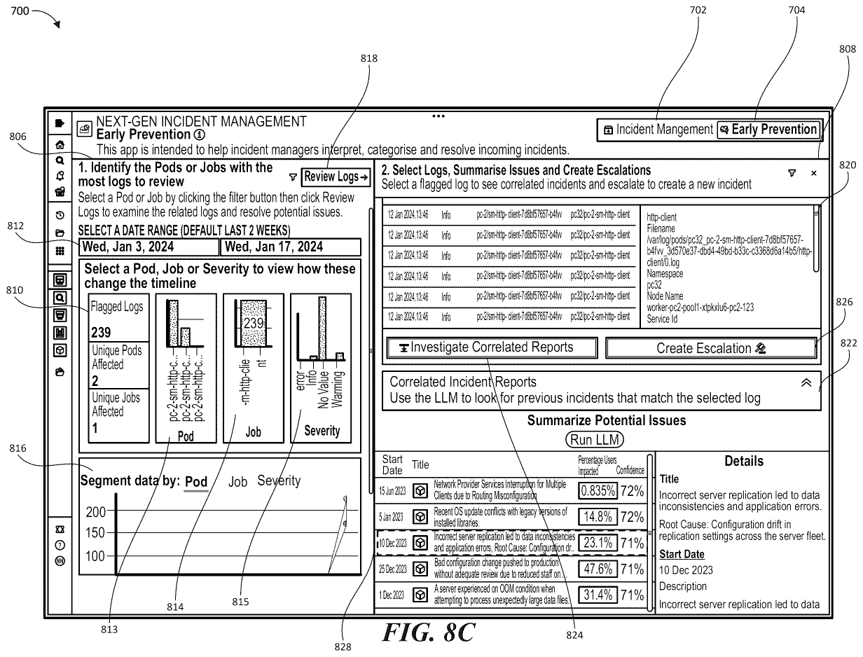

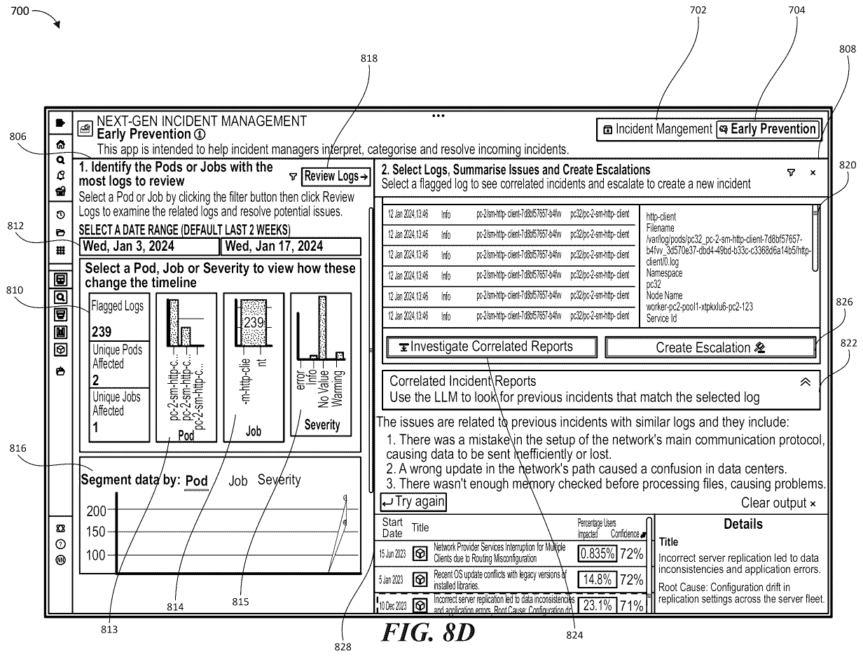

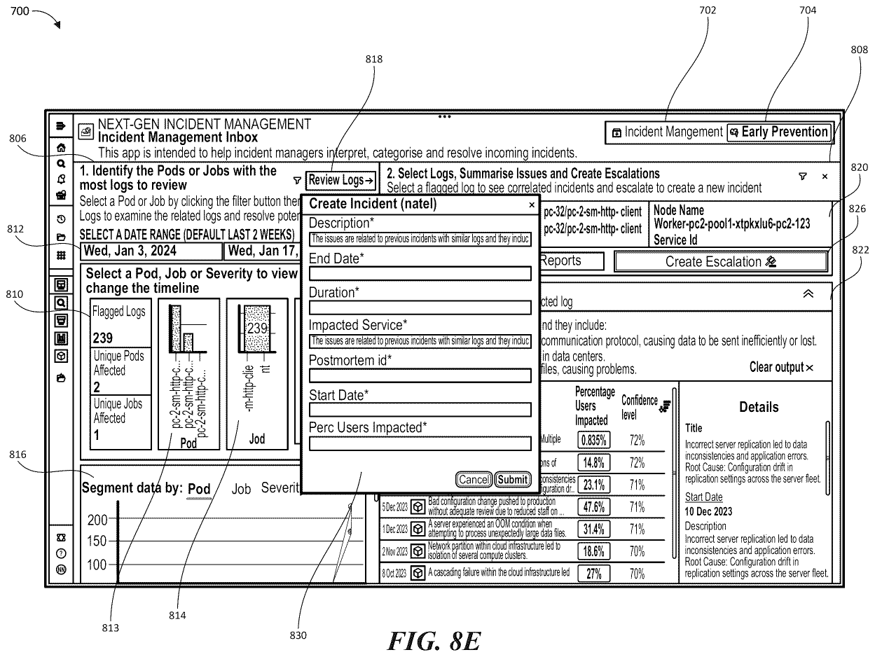

FIGS. 7A-7C and 8A-8E illustrate an example user interface 700 for allowing a user to prioritize one or more incidents, identify a root cause of one or more incidents, and identify a proposed solution for one or more incidents. The user interface 700 may be displayed by a user device 150 in response to receiving user interface data generated by the incident response and prevention system 110.

As illustrated in FIG. 7A, the user interface 700 may include an incident management user interface element 702 (e.g., a button, a menu item, etc.) and an early prevention user interface element 704 (e.g., a button, a menu item, etc.). The user can toggle between selection of the incident management user interface element 702 to prioritize one or more current incidents and/or to identify a root cause of and/or resolution to one or more current incidents and selection of the early prevention user interface element 704 to identify potential incidents. Here, the user has selected the incident management user interface element 702. Selection of the incident management user interface element 702 may cause the user interface 700 to depict an incident priority window or container 706 and a proposed solution window or container 708.

Within the incident priority window 706, one or more current incidents may be displayed. Each current incident may be displayed with an indication of a priority of the respective current incident, a title of the respective current incident, and a time at which the respective current incident occurred. A user can select any of the listed current incidents to prioritize or re-prioritize the selected current incident and/or multiple current incidents. For example, the user may select current incident 710 and select prioritize user interface element 712 to prioritize the current incident 710. In particular, selection of the prioritize user interface element 712 may result in the incident prioritizer 112 prioritizing the current incident 710.

Selection of the current incident 710 may also cause the proposed solution window or container 708 to depict a related postmortem reports sub-window 718. Postmortem reports listed in the related postmortem reports sub-window 718 may be for incidents that appear similar to the selected current incident 710 as identified by the incident response and prevention system 110 using a semantic search. Each listed postmortem report may include a title of the respective report and a confidence level that represents how similar the incident of the respective report is to the current incident 710 (where a higher confidence level indicates a higher degree of similarity between the incident of the respective report and the current incident 710). Here, the user may have selected postmortem report 720, which causes the related postmortem reports sub-window 718 to further depict text that describes the problem of the incident associated with the selected postmortem report 720, a root cause of the incident associated with the selected postmortem report 720, and/or one or more steps or operations executed to resolve the incident associated with the selected postmortem report 720.

To understand the selected current incident 710, the user can select summary generation user interface element 714 to obtain a summary of the current incident 710. As illustrated in FIG. 7B, the user has selected the summary generation user interface element 714. In response, the incident response and prevention system 110 uses the LLM 130 to generate a summary 724 of the selected current incident 710 and the summary 724 is displayed in the proposed solution window 708.

To identify one or more steps or operations that can be implemented to resolve the selected current incident 710, the user can select propose solution user interface element 716. As illustrated in FIG. 7C, the user has selected the propose solution user interface element 716. In response, the incident response and prevention system 110 uses the LLM 130 to generate a proposed solution 726 to the selected current incident 710 and the proposed solution 726 is displayed in the proposed solution window 708.

The proposed solution window 708 may further include an approve user interface element 728 that is displayed in conjunction with the proposed solution 726. The user may select the approve user interface element 728 if the user approves or confirms the proposed solution 726. Optionally, selection of the proposed solution 726 may cause the incident response and prevention system 110 to automatically implement some or all of the steps or operations of the proposed solution 726.

As illustrated in FIG. 8A, the user has selected the early prevention user interface element 704. Selection of the early prevention user interface element 704 may cause the user interface 700 to depict a logs window or container 806 and potential incident summary window or container 808.

Within the logs window 806, various information is depicted, including a summary 810 of logs that fall within a specified time range 812 (e.g., a number of logs flagged as including errors or warnings, a number of pods from which flagged logs originate, a number of unique jobs affected by the flagged logs, etc.) and/or other log filter and that are flagged as including errors or warnings, a graph 813 that identifies a number of flagged logs by pod, a graph 814 that identifies a number of flagged logs per job, a graph 815 that identifies a number of flagged logs that correspond to various severity levels, a graph 816 that identifies a number of flagged logs per pod, and/or the like.

The logs window 806 may further include a review logs user interface element 818. The user may select the review logs user interface element 818 once the user is satisfied with the filters used to identify the flagged logs. As illustrated in FIG. 8B, selection of the review logs user interface element 818 may cause the potential incident summary window 808 to expand (and/or the logs window 806 to contract) and depict a list 820 of flagged logs, a list 822 of correlated incident reports, an investigate correlated reports user interface element 824, and a create escalation user interface element 826. The list 820 of flagged logs may include, for each flagged log, an identification of a timestamp of the respective flagged log, a severity of the respective flagged log, a pod from which the respective flagged log originated, a job from which the respective flagged log originated, and further details of a selected flagged log in the list 820 of flagged logs (e.g., text, images, audio, etc. that forms the selected flagged log).

As illustrated in FIG. 8C, upon expansion of the list 822 of correlated incident reports, the user interface 700 can depict the list 822 of correlated incident reports and, for each correlated incident report, identify a start date of the respective correlated incident report, a title of the respective correlated incident report, the percentage of users impacted by the prior incident corresponding to the respective correlated incident report, and a confidence score of how similar the prior incident corresponding to the respective correlated incident report is to the potential incident indicated by the flagged logs. As used herein, a correlated incident report may be an incident or postmortem report for a prior incident that the incident response and prevention system 110 has identified (e.g., using a semantic search) as being similar to a potential incident. Here, correlated incident report 828 is selected, which causes the list 822 of correlated incident reports to further display details of the correlated incident report 828 (e.g., text of the report).

As illustrated in FIG. 8D, selection of the investigate correlated reports user interface element 824, the incident response and prevention system 110 may use the LLM 130 to generate a summary of the issues identified in the correlated incident reports and the list 822 of correlated incident reports then depicts the summary.

As illustrated in FIG. 8E, selection of the create escalation user interface element 826 may cause the user interface 700 to depict a create incident window 830. The create incident window 830 may allow a user to describe a potential incident, provide an end date for the potential incident, provide a duration for the potential incident, describe services impacted by or that will be impacted by the potential incident, a postmortem identifier for the potential incident, a start date for the potential incident, a percentage of users impacted by or that will be impacted by the potential incident, and/or the like.

### Additional Example Implementations and Details

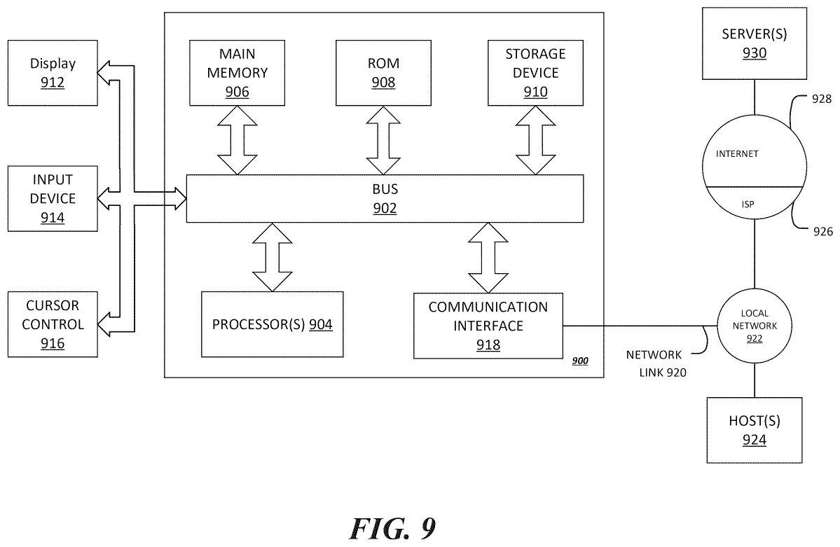

In an implementation of the system (e.g., one or more aspects of the incident response and prevention system 110, one or more aspects of the computing environment 100, and/or the like) may comprise, or be implemented in, a “virtual computing environment”. As used herein, the term “virtual computing environment” should be construed broadly to include, for example, computer-readable program instructions executed by one or more processors (e.g., as described in the example of FIG. 9) to implement one or more aspects of the modules and/or functionality described herein. Further, in this implementation, one or more services/modules/engines and/or the like of the system may be understood as comprising one or more rules engines of the virtual computing environment that, in response to inputs received by the virtual computing environment, execute rules and/or other program instructions to modify operation of the virtual computing environment. For example, a request received from a user computing device may be understood as modifying operation of the virtual computing environment to cause the request access to a resource from the system. Such functionality may comprise a modification of the operation of the virtual computing environment in response to inputs and according to various rules. Other functionality implemented by the virtual computing environment (as described throughout this disclosure) may further comprise modifications of the operation of the virtual computing environment, for example, the operation of the virtual computing environment may change depending on the information gathered by the system. Initial operation of the virtual computing environment may be understood as an establishment of the virtual computing environment. In various implementations the virtual computing environment may comprise one or more virtual machines, containers, and/or other types of emulations of computing systems or environments. In various implementations the virtual computing environment may comprise a hosted computing environment that includes a collection of physical computing resources that may be remotely accessible and may be rapidly provisioned as needed (commonly referred to as “cloud” computing environment).

Implementing one or more aspects of the system as a virtual computing environment may advantageously enable executing different aspects or modules of the system on different computing devices or processors, which may increase the scalability of the system. Implementing one or more aspects of the system as a virtual computing environment may further advantageously enable sandboxing various aspects, data, or services/modules of the system from one another, which may increase security of the system by preventing, e.g., malicious intrusion into the system from spreading. Implementing one or more aspects of the system as a virtual computing environment may further advantageously enable parallel execution of various aspects or modules of the system, which may increase the scalability of the system. Implementing one or more aspects of the system as a virtual computing environment may further advantageously enable rapid provisioning (or de-provisioning) of computing resources to the system, which may increase scalability of the system by, e.g., expanding computing resources available to the system or duplicating operation of the system on multiple computing resources. For example, the system may be used by thousands, hundreds of thousands, or even millions of users simultaneously, and many megabytes, gigabytes, or terabytes (or more) of data may be transferred or processed by the system, and scalability of the system may enable such operation in an efficient and/or uninterrupted manner.

Various implementations of the present disclosure may be a system, a method, and/or a computer program product at any possible technical detail level of integration. The computer program product may include a computer-readable storage medium (or mediums) having computer-readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer-readable storage medium (or mediums). Computer-readable storage mediums may also be referred to herein as computer-readable storage or computer-readable storage devices.

The computer-readable storage medium can be a tangible device that can retain and store data and/or instructions for use by an instruction execution device. The computer-readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions (as also referred to herein as, for example, “code,” “instructions,” “module,” “application,” “software application,” “service,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. Computer-readable program instructions may be callable from other instructions or from itself, and/or may be invoked in response to detected events or interrupts. Computer-readable program instructions configured for execution on computing devices may be provided on a computer-readable storage medium, and/or as a digital download (and may be originally stored in a compressed or installable format that requires installation, decompression, or decryption prior to execution) that may then be stored on a computer-readable storage medium. Such computer-readable program instructions may be stored, partially or fully, on a memory device (e.g., a computer-readable storage medium) of the executing computing device, for execution by the computing device. The computer-readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In various implementations, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart(s) and/or block diagram(s) block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowcharts and block diagrams in the Figures illustrate the architecture, functionality, and operation of possible implementations of systems, methods, and computer program products according to various implementations of the present disclosure. In this regard, each block in the flowchart or block diagrams may represent a service, module, segment, or portion of instructions, which comprises one or more executable instructions for implementing the specified logical function(s). In various alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted or optional in various implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, and/or the like with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above implementations may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows 11, Windows Server, and/or the like), Windows CE, Unix, Linux, SunOS, Solaris, Blackberry OS, VxWorks, or other suitable operating systems. In other implementations, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

For example, FIG. 9 shows a block diagram that illustrates a computer system 900 upon which various implementations and/or aspects (e.g., one or more aspects of the computing environment 100, one or more aspects of the incident response and prevention system 110, one or more aspects of the user device 150, one or more aspects of the LLM 130, one or more aspects of the physical machine 180, and/or the like) may be implemented. Multiple such computer systems 900 may be used in various implementations of the present disclosure. Computer system 900 includes a bus 902 or other communication mechanism for communicating information, and a hardware processor, or multiple processors, 1004 coupled with bus 902 for processing information. Hardware processor(s) 904 may be, for example, one or more general purpose microprocessors.

Computer system 900 also includes a main memory 906, such as a random-access memory (RAM), cache and/or other dynamic storage devices, coupled to bus 902 for storing information and instructions to be executed by processor 904. Main memory 906 also may be used for storing temporary variables or other intermediate information during execution of instructions to be executed by processor 904. Such instructions, when stored in storage media accessible to processor 904, render computer system 900 into a special-purpose machine that is customized to perform the operations specified in the instructions. The main memory 906 may, for example, include instructions to implement server instances, queuing modules, memory queues, storage queues, user interfaces, and/or other aspects of functionality of the present disclosure, according to various implementations.

Computer system 900 further includes a read only memory (ROM) 908 or other static storage device coupled to bus 902 for storing static information and instructions for processor 904. A storage device 910, such as a magnetic disk, optical disk, or USB thumb drive (Flash drive), and/or the like, is provided and coupled to bus 902 for storing information and instructions.

Computer system 900 may be coupled via bus 902 to a display 912, such as a cathode ray tube (CRT) or LCD display (or touch screen), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane. In some implementations, the same direction information and command selections as cursor control may be implemented via receiving touches on a touch screen without a cursor.

Computer system 900 may include a user interface module to implement a GUI that may be stored in a mass storage device as computer executable program instructions that are executed by the computing device(s). Computer system 900 may further, as described below, implement the techniques described herein using customized hard-wired logic, one or more ASICs or FPGAs, firmware and/or program logic which in combination with the computer system causes or programs computer system 900 to be a special-purpose machine. According to one implementation, the techniques herein are performed by computer system 900 in response to processor(s) 904 executing one or more sequences of one or more computer-readable program instructions contained in main memory 906. Such instructions may be read into main memory 906 from another storage medium, such as storage device 910. Execution of the sequences of instructions contained in main memory 906 causes processor(s) 904 to perform the process steps described herein. In alternative implementations, hard-wired circuitry may be used in place of or in combination with software instructions.

Various forms of computer-readable storage media may be involved in carrying one or more sequences of one or more computer-readable program instructions to processor 904 for execution. For example, the instructions may initially be carried on a magnetic disk or solid-state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN (or WAN component to communicated with a WAN). Wireless links may also be implemented. In any such implementation, communication interface 918 sends and receives electrical, electromagnetic, or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 1026. ISP 926 in turn provides data communication services through the worldwide packet data communication network now commonly referred to as the “Internet” 1028. Local network 922 and Internet 928 both use electrical, electromagnetic, or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

As described above, in various implementations certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain implementations, one or more of the computing devices and/or systems of the disclosure may include mobile computing devices, and user interfaces may be accessible through such mobile computing devices (for example, smartphones and/or tablets).

Many variations and modifications may be made to the above-described implementations, the elements of which are to be understood as being among other acceptable examples. All such modifications and variations are intended to be included herein within the scope of this disclosure. The foregoing description details certain implementations. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, and/or the like may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain implementations require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and may possibly include such components as memory, input/output devices, and/or network interfaces, among others.

While the above detailed description has shown, described, and pointed out novel features as applied to various implementations, it may be understood that various omissions, substitutions, and changes in the form and details of the devices or processes illustrated may be made without departing from the spirit of the disclosure. As may be recognized, certain implementations of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

### Example Clauses

Examples of implementations of the present disclosure can be described in view of the following example clauses. The features recited in the below example implementations can be combined with additional features disclosed herein. Furthermore, additional inventive combinations of features are disclosed herein, which are not specifically recited in the below example implementations, and which do not include the same features as the specific implementations below. For sake of brevity, the below example implementations do not identify every inventive aspect of this disclosure. The below example implementations are not intended to identify key features or essential features of any subject matter described herein. Any of the example clauses below, or any features of the example clauses, can be combined with any one or more other example clauses, or features of the example clauses or other features of the present disclosure.

Clause 1. A computerized method, performed by a computing system having one or more hardware computer processors and one or more computer-readable storage devices storing software instructions executable by the computing system, the computerized method comprising: receiving a request for a solution to a current incident from a user device, wherein the request comprises incident data associated with the current incident; retrieving a plurality of prior embeddings corresponding to one or more prior incidents; converting the incident data into a first embedding; performing a semantic search based on the first embedding and the plurality of prior embeddings to identify a subset of the plurality of prior embeddings; transmitting, to a large language model (LLM), the subset of the plurality of prior embeddings and a first prompt that instructs the LLM to generate the solution to the current incident based on the subset of the prior embeddings; receiving the solution to the current incident from the LLM in response to transmitting the subset of the plurality of prior embeddings and the prompt to the LLM, wherein the solution comprises one or more steps to execute; and generating user interface data that, when processed by the user device, causes the user device to display a user interface that depicts the one or more steps to execute.

Clause 2. The computerized method of Clause 1, wherein the current incident is associated with a physical machine, and wherein the computerized method further comprises: receiving from the user device an approval of the solution to the current incident; and transmitting an instruction to the physical machine to execute at least one of the one or more steps.

Clause 3. The computerized method of Clause 1, wherein the current incident is associated with a physical machine, and wherein the computerized method further comprises: receiving from the user device an approval of the solution to the current incident; and transmitting an instruction to a computing system separate from the physical machine and that interacts with the physical machine to execute at least one of the one or more steps.

Clause 4. The computerized method of Clause 1, further comprising: receiving a second request from the user device to prioritize the current incident, wherein the second request comprises a user-generated report of the current incident; transmitting, to the LLM, the user-generated report and a second prompt that instructs the LLM to generate a score for the user-generated report based on a sentiment analysis of content of the user-generated report; receiving the score from the LLM; generating a priority score for the current incident based on a weighted combination of at least one of the score received from the LLM, a number of users impacted by the current incident, or a time that has passed since the current incident occurred; and generating second user interface data that, when processed by the user device, causes the user device to display a second user interface that depicts the current incident in accordance with the priority score.

Clause 5. The computerized method of Clause 1, further comprising: receiving a second request from the user device to prioritize the current incident, wherein the second request comprises a user-generated report of the current incident; transmitting, to the LLM, the user-generated report and a second prompt that instructs the LLM to generate a score for the user-generated report based on a sentiment analysis of content of the user-generated report; receiving the score from the LLM; providing at least one of the score received from the LLM, a number of users impacted by the current incident, or a time that has passed since the current incident occurred as an input to a machine learning model, wherein providing at least one of the score received from the LLM, the number of users impacted by the current incident, or the time that has passed since the current incident occurred as the input to the machine learning model causes the machine learning model to output a priority score for the current incident; and generating second user interface data that, when processed by the user device, causes the user device to display a second user interface that depicts the current incident in accordance with the priority score.

Clause 6. The computerized method of Clause 1, further comprising: retrieving second incident data corresponding to the one or more prior incidents; transmitting, to the LLM, the second incident data and a second prompt that instructs the LLM to generate a plurality of learnings based on the second incident data; receiving the plurality of learnings from the LLM; and converting the plurality of learnings into the plurality of prior embeddings.

Clause 7. The computerized method of Clause 1, further comprising: receiving from the user device data corresponding to a current log to analyze; retrieving data corresponding to a plurality of prior logs; performing a second semantic search based on the data corresponding to the current log and the data corresponding to the plurality of prior logs to identify a subset of the plurality of prior logs; identifying a second subset of the plurality of prior embeddings that are associated with the subset of the plurality of prior logs; and transmitting, to the LLM, the second subset of the plurality of prior embeddings and a prompt that instructs the LLM to identify a potential incident based on the second subset of the plurality of prior embeddings.

Clause 8. The computerized method of Clause 7, further comprising: receiving an identification of the prior incident from the LLM; and generating second user interface data that, when processed by the user device, causes the user device to display a second user interface that depicts the identification of the prior incident.

Clause 9. The computerized method of Clause 8, further comprising: converting second incident data corresponding to the potential incident into a second embedding; performing a third semantic search based on the second embedding and the plurality of prior embeddings to identify a third subset of the plurality of prior embeddings; transmitting, to the LLM, the third subset of the plurality of prior embeddings and a third prompt that instructs the LLM to generate a second solution to the potential incident based on the third subset of the prior embeddings; receiving the second solution to the potential incident from the LLM in response to transmitting the third subset of the plurality of prior embeddings and the third prompt to the LLM, wherein the second solution comprises one or more second steps to execute; and generating third user interface data that, when processed by the user device, causes the user device to display a third user interface that depicts the one or more second steps to execute.

Clause 10. The computerized method of Clause 7, further comprising receiving an identification from the LLM that additional information is needed prior to identification of the prior incident.

Clause 11. The computerized method of Clause 10, further comprising transmitting an instruction to the user device to inspect a physical machine from which the current log originated.

Clause 12. The computerized method of Clause 11, further comprising: transmitting, to the LLM, additional data derived from the inspection of the physical machine; receiving an identification of the prior incident from the LLM; and generating second user interface data that, when processed by the user device, causes the user device to display a second user interface that depicts the identification of the prior incident.

Clause 13. The computerized method of Clause 10, further comprising adding a meeting to a calendar of a user of the user device to remind the user to inspect a physical machine from which the current log originated.

Clause 14. The computerized method of Clause 1, wherein performing the semantic search further comprises: determining a cosine distance between the first embedding and each of the prior embeddings in the plurality of prior embeddings; and identifying that each prior embedding in the subset of the plurality of prior embeddings is within a threshold cosine distance of the first embedding.

Clause 15. The computerized method of Clause 1, wherein the plurality of prior embeddings are derived from at least one of types of the one or more prior incidents, times that the one or more prior incidents occurred, consequences of the one or more prior incidents, how long the one or more prior incidents lasted until service was resolved, one or more postmortem reports previously generated in response to the one or more prior incidents, user manuals that describe functionality of hardware used to implement the service experiencing downtime, or one or more emails related to the one or more prior incidents.

Clause 16. The computerized method of Clause 1, further comprising receiving a root cause of the current incident from the LLM in response to transmitting the subset of the plurality of prior embeddings and the prompt to the LLM.

Clause 17. The computerized method of Clause 16, wherein the user interface depicts the root cause of the current incident.

Clause 18. The computerized method of Clause 1, wherein converting the incident data into a first embedding further comprises converting the incident data into the first embedding using an embedding model.

Clause 19. A system comprising: one or more computer-readable storage mediums storing program instructions; and one or more processors configured to execute the program instructions to cause the system to perform the computerized method of Clause 1.

Clause 20. One or more computer-readable storage mediums storing program instructions, the program instructions executable by one or more processors to cause the one or more processors to perform the computerized method of Clause 1.

What is claimed is:

1. A computerized method, performed by a computing system having one or more hardware computer processors and one or more computer-readable storage devices storing software instructions executable by the computing system, the computerized method comprising:
receiving a request for a solution to a current incident from a user device, wherein the request comprises incident data associated with the current incident;
retrieving a plurality of prior embeddings corresponding to one or more prior incidents;
converting the incident data into a first embedding;
performing a semantic search based on the first embedding and the plurality of prior embeddings to identify a subset of the plurality of prior embeddings;
transmitting, to a large language model (LLM), the subset of the plurality of prior embeddings and a first prompt that instructs the LLM to generate the solution to the current incident based on the subset of the prior embeddings;
receiving the solution to the current incident from the LLM in response to transmitting the subset of the plurality of prior embeddings and the prompt to the LLM, wherein the solution comprises one or more steps to execute; and
generating user interface data that, when processed by the user device, causes the user device to display a user interface that depicts the one or more steps to execute.

2. The computerized method of claim 1, wherein the current incident is associated with a physical machine, and wherein the computerized method further comprises:
receiving from the user device an approval of the solution to the current incident; and
transmitting an instruction to the physical machine to execute at least one of the one or more steps.

3. The computerized method of claim 1, wherein the current incident is associated with a physical machine, and wherein the computerized method further comprises:
receiving from the user device an approval of the solution to the current incident; and
transmitting an instruction to a computing system separate from the physical machine and that interacts with the physical machine to execute at least one of the one or more steps.

4. The computerized method of claim 1, further comprising:
receiving a second request from the user device to prioritize the current incident,
wherein the second request comprises a user-generated report of the current incident;
transmitting, to the LLM, the user-generated report and a second prompt that instructs the LLM to generate a score for the user-generated report based on a sentiment analysis of content of the user-generated report;
receiving the score from the LLM;
generating a priority score for the current incident based on a weighted combination of at least one of the score received from the LLM, a number of users impacted by the current incident, or a time that has passed since the current incident occurred; and
generating second user interface data that, when processed by the user device, causes the user device to display a second user interface that depicts the current incident in accordance with the priority score.

5. The computerized method of claim 1, further comprising:
receiving a second request from the user device to prioritize the current incident, wherein the second request comprises a user-generated report of the current incident;
transmitting, to the LLM, the user-generated report and a second prompt that instructs the LLM to generate a score for the user-generated report based on a sentiment analysis of content of the user-generated report;
receiving the score from the LLM;
providing at least one of the score received from the LLM, a number of users impacted by the current incident, or a time that has passed since the current incident occurred as an input to a machine learning model, wherein providing at least one of the score received from the LLM, the number of users impacted by the current incident, or the time that has passed since the current incident occurred as the input to the machine learning model causes the machine learning model to output a priority score for the current incident; and
generating second user interface data that, when processed by the user device, causes the user device to display a second user interface that depicts the current incident in accordance with the priority score.

6. The computerized method of claim 1, further comprising:
retrieving second incident data corresponding to the one or more prior incidents;
transmitting, to the LLM, the second incident data and a second prompt that instructs the LLM to generate a plurality of learnings based on the second incident data;
receiving the plurality of learnings from the LLM; and
converting the plurality of learnings into the plurality of prior embeddings.

7. The computerized method of claim 1, further comprising:
receiving from the user device data corresponding to a current log to analyze;
retrieving data corresponding to a plurality of prior logs;
performing a second semantic search based on the data corresponding to the current log and the data corresponding to the plurality of prior logs to identify a subset of the plurality of prior logs;
identifying a second subset of the plurality of prior embeddings that are associated with the subset of the plurality of prior logs; and
transmitting, to the LLM, the second subset of the plurality of prior embeddings and a prompt that instructs the LLM to identify a potential incident based on the second subset of the plurality of prior embeddings.

8. The computerized method of claim 7, further comprising:
receiving an identification of the prior incident from the LLM; and
generating second user interface data that, when processed by the user device, causes the user device to display a second user interface that depicts the identification of the prior incident.

9. The computerized method of claim 8, further comprising:
converting second incident data corresponding to the potential incident into a second embedding;
performing a third semantic search based on the second embedding and the plurality of prior embeddings to identify a third subset of the plurality of prior embeddings;
transmitting, to the LLM, the third subset of the plurality of prior embeddings and a third prompt that instructs the LLM to generate a second solution to the potential incident based on the third subset of the prior embeddings;
receiving the second solution to the potential incident from the LLM in response to transmitting the third subset of the plurality of prior embeddings and the third prompt to the LLM, wherein the second solution comprises one or more second steps to execute; and
generating third user interface data that, when processed by the user device, causes the user device to display a third user interface that depicts the one or more second steps to execute.

10. The computerized method of claim 7, further comprising receiving an identification from the LLM that additional information is needed prior to identification of the prior incident.

11. The computerized method of claim 10, further comprising transmitting an instruction to the user device to inspect a physical machine from which the current log originated.

12. The computerized method of claim 11, further comprising:
transmitting, to the LLM, additional data derived from the inspection of the physical machine;
receiving an identification of the prior incident from the LLM; and
generating second user interface data that, when processed by the user device, causes the user device to display a second user interface that depicts the identification of the prior incident.

13. The computerized method of claim 10, further comprising adding a meeting to a calendar of a user of the user device to remind the user to inspect a physical machine from which the current log originated.

14. The computerized method of claim 1, wherein performing the semantic search further comprises:
determining a cosine distance between the first embedding and each of the prior embeddings in the plurality of prior embeddings; and
identifying that each prior embedding in the subset of the plurality of prior embeddings is within a threshold cosine distance of the first embedding.

15. The computerized method of claim 1, wherein the plurality of prior embeddings are derived from at least one of types of the one or more prior incidents, times that the one or more prior incidents occurred, consequences of the one or more prior incidents, how long the one or more prior incidents lasted until service was resolved, one or more postmortem reports previously generated in response to the one or more prior incidents, user manuals that describe functionality of hardware used to implement the service experiencing downtime, or one or more emails related to the one or more prior incidents.

16. The computerized method of claim 1, further comprising receiving a root cause of the current incident from the LLM in response to transmitting the subset of the plurality of prior embeddings and the prompt to the LLM.

17. The computerized method of claim 16, wherein the user interface depicts the root cause of the current incident.

18. The computerized method of claim 1, wherein converting the incident data into a first embedding further comprises converting the incident data into the first embedding using an embedding model.

19. A system comprising:
one or more computer-readable storage mediums storing program instructions; and
one or more processors configured to execute the program instructions to cause the system to perform the computerized method of claim 1.

20. One or more computer-readable storage mediums storing program instructions, the program instructions executable by one or more processors to cause the one or more processors to perform the computerized method of claim 1.
